(19) United States
(12) Patent Application Publication
(10) Pub. No.: US 2020/0288359 A1
(43) Pub. Date: Sep. 10, 2020

(54) BI-CASTING BASED MOBILITY CONTROL METHOD, AND APPARATUS THEREFOR

(71) Applicant: ELECTRONICS AND TELECOMMUNICATIONS RESEARCH INSTITUTE, Daejeon (KR)

(72) Inventor: Jae Heung KIM, Daejeon (KR)

(73) Assignee: ELECTRONICS AND TELECOMMUNICATIONS RESEARCH INSTITUTE, Daejeon (KR)

(21) Appl. No.: 16/809,240

(22) Filed: Mar. 4, 2020

(30) Foreign Application Priority Data
Mar. 8, 2019 (KR) 10-2019-0027128
Mar. 28, 2019 (KR) 10-2019-0035777
Apr. 18, 2019 (KR) 10-2019-0045296
Feb. 11, 2020 (KR) 10-2020-0016239

(51) Int. Cl. H04W 36/00; H04W 76/15; H04W 36/08; H04W 36/30; H04W 8/24; H04W 24/10

(52) U.S. Cl. CPC H04W 36/0094; H04W 36/0058; H04W 76/15; H04W 24/10; H04W 36/30; H04W 8/24; H04W 36/08

(57) ABSTRACT

An operation method for a handover, performed by a terminal, may comprise receiving, from a base station of a serving cell, a first message including parameters for measurement and reporting; transmitting a second message to the base station of the serving cell, the second message including a measurement result based on the parameters for measurement and reporting; receiving a third message from the base station of the serving cell, the third message instructing to receive services simultaneously from the serving cell and a target cell; performing a radio access request procedure with the target cell; and transmitting a fourth message to the base station of the serving cell, the fourth message reporting completion of configuration for receiving the services simultaneously from the serving cell and the target cell.

### CROSS-REFERENCE TO RELATED APPLICATIONS

This application claims priority to Korean Patent Applications No. 10-2019-0027128 filed on Mar. 8, 2019, No. 10-2019-0035777 filed on Mar. 28, 2019, No. 10-2019-0045296 filed on Apr. 18, 2019, and No. 10-2020-0016239 filed on Feb. 11, 2020 with the Korean Intellectual Property Office (KIPO), the entire contents of which are hereby incorporated by reference.

### BACKGROUND

### 1. Technical Field

The present disclosure relates generally to mobility control in a communication system, and more specifically, to a method and an apparatus of controlling mobility for enhancing mobility functions, when a function of bi-casting to a plurality of nodes in a network of a cellular mobile communication system.

### 2. Related Art

In order to cope with the explosion of wireless data, a mobile communication system considers a 6 GHz to 90 GHz band as a transmission frequency for a wide system bandwidth. In such the high frequency band, it is assumed that a small base station is used due to deterioration of received signal performance due to attenuation and reflection of radio waves.

In order to deploy the mobile communication system based on small base stations each having a small service coverage, considering a millimeter frequency band of 6 GHz to 90 GHz band, instead of implementing radio protocol functions of the mobile communication system in each small base station, considered is a method of configuring the mobile communication system by utilizing a plurality of transmission and reception points (TRPs) through a functional split scheme, in which the base station functions are divided into a plurality of remote radio transmission and reception blocks and one centralized baseband processing function block, a carrier aggregation function, a dual connectivity function, a duplicated transmission function, or the like.

In the mobile communication system employing such the functional split, the bi-casting function, or the duplicated transmission function, mobility function support functions are required to guarantee service continuity in radio interfaces for a backhaul connecting a base station and a core network, and a fronthaul connecting the remote radio transmission and reception blocks (e.g., TRPs, Remote Radio Heads (RRHs), etc.) and the baseband processing block, as well as access links between the base station and terminals.

### SUMMARY

Accordingly, exemplary embodiments of the present disclosure provide mobility control methods to which bi-casting is applied.

Accordingly, exemplary embodiments of the present disclosure provide apparatuses for supporting the mobility control method to which bi-casting is applied.

According to an exemplary embodiment of the present disclosure, an operation method for a handover, performed by a terminal, may comprise receiving, from a base station of a serving cell, a first message including parameters for measurement and reporting; transmitting a second message to the base station of the serving cell, the second message including a measurement result based on the parameters for measurement and reporting; receiving a third message from the base station of the serving cell, the third message instructing to receive services simultaneously from the serving cell and a target cell; performing a radio access request procedure with the target cell; and transmitting a fourth message to the base station of the serving cell, the fourth message reporting completion of configuration for receiving the services simultaneously from the serving cell and the target cell.

The second message may include information indicating that the terminal requests to receive the services simultaneously from the serving cell and the target cell or information reporting satisfaction of a first condition for the terminal to receive the services simultaneously from the serving cell and the target cell.

The first condition may be a condition of satisfying at least one of: a case when a radio channel quality for the serving cell is worse than a first reference value; a case when a radio channel quality for the target cell is better than a second reference value; a case when the radio channel quality for the serving cell is worse than the first reference value and the radio channel quality for the target cell is better than the second reference value; and a case when a difference between the radio channel quality for the serving cell and the radio channel quality for the target cell satisfies a preconfigured reference value.

The operation method may further comprise, in response to satisfaction of a second condition for determining that the terminal is not able to receive the services simultaneously from the serving cell and the target cell, transmitting a fifth message to the serving cell and/or the target cell.

The second condition may be a condition of satisfying at least one of: a case when the radio channel quality for the serving cell or the target cell is worse than a third reference value; a case when the radio channel quality for the serving cell or the target cell is better than the first reference value; and a case when the radio channel quality for the serving cell (or the target cell) is worse than the third reference value and the radio channel quality for the target cell (or the serving cell) is better than the first reference value.

The operation method may further comprise transmitting, to the base station of the serving cell, capability information indicating that the terminal is capable of receiving the services simultaneously from the serving cell and the target cell.

The third message may include at least one of a reference condition or threshold value of a radio channel for receiving a simultaneous service, a parameter for performing an operation, a triggering condition, a measurement or reporting reference value or threshold value, or a related timer configuration parameter.

The base station of the serving cell may determine that the serving cell and the target cell are to simultaneously provide the services to the terminal, a base station of the target cell may accept the determination, and then the base station of the serving cell may transmit the third message.

The base station of the serving cell may request a handover of the terminal to a base station of the target cell, the base station of the target cell may determine that the serving cell and the target cell are to simultaneously provide the services to the terminal, the base station of the serving cell may accept the determination, and then the base station of the serving cell may transmit the third message.

When the base station of the serving cell requests the handover of the terminal to the base station of the target cell, information informing that a simultaneous service triggered by the base station of the target cell can be provided, information on the target cell, that allows the base station of the target cell to trigger the simultaneous service, or capability information of the terminal informing whether the terminal is capable of supporting the simultaneous service may be transferred to the base station of the target cell.

According to another exemplary embodiment of the present disclosure, an operation method for a handover of a terminal, performed by a base station of a serving cell, may comprise transmitting, to the terminal, a first message including parameters for measurement and reporting; receiving, from the terminal, a second message including a measurement result based on the parameters for measurement and reporting; determining whether the serving cell and a target cell simultaneously provide services to the terminal based on the measurement result, or requesting a handover of the terminal to a base station of the target ell and receiving, from the base station of target cell, a result of determination on whether the serving cell and the target cell simultaneously provide the services to the terminal; in response to determination that the serving cell and the target cell simultaneously provide the services to the terminal, transmitting, to the terminal, a third message instructing the terminal to receive the services simultaneously from the serving cell and the target cell; and receiving, from the terminal, a fourth message reporting completion of configuration for receiving the services simultaneously from the serving cell and the target cell.

The second message may include information that the terminal requests to receive the services simultaneously from the serving cell and the target cell or information reporting satisfaction of a first condition for the terminal to receive the services simultaneously from the serving cell and the target cell.

The first condition may be a condition of satisfying at least one of: a case when a radio channel quality for the serving cell is worse than a first reference value; a case when a radio channel quality for the target cell is better than a second reference value; a case when the radio channel quality for the serving cell is worse than the first reference value and the radio channel quality for the target cell is better than the second reference value; and a case when a difference between the radio channel quality for the serving cell and the radio channel quality for the target cell satisfies a preconfigured reference value.

The operation method may further comprise, in response to satisfaction of a second condition for determining that the terminal is not able to receive the services simultaneously from the serving cell and the target cell, receiving a fifth message from the terminal.

The second condition may be a condition of satisfying at least one of: a case when the radio channel quality for the serving cell or the target cell is worse than a third reference value; a case when the radio channel quality for the serving cell or the target cell is better than the first reference value; and a case when the radio channel quality for the serving cell (or the target cell) is worse than the third reference value and the radio channel quality for the target cell (or the serving cell) is better than the first reference value.

The third message may include at least one of a reference condition or threshold value of a radio channel for receiving a simultaneous service, a parameter for performing an operation, a triggering condition, a measurement or reporting reference value or threshold value, or a related timer configuration parameter.

According to yet another exemplary embodiment of the present disclosure, an operation method for a handover of a terminal, performed by a base station of a target cell, may comprise receiving, from a base station of a serving cell, a first message requesting a handover of the terminal and determining whether the serving cell and the target cell simultaneously provide services to the terminal, or receiving, from the base station of the serving cell, information indicating that the serving cell and the target cell are to simultaneously provide the services to the terminal; transmitting, to the base station of the serving cell, a second message including a result of the determination; performing a radio access request procedure with the terminal; and receiving, from the terminal, a third message reporting completion of configuration for receiving the services simultaneously from the serving cell and the target cell.

The first message may include information indicating that the terminal requests to receive the services simultaneously from the serving cell and the target cell, or information reporting satisfaction of a first condition for the terminal to receive the services simultaneously from the serving cell and the target cell.

The first condition may be a condition of satisfying at least one of: a case when a radio channel quality for the serving cell is worse than a first reference value; a case when a radio channel quality for the target cell is better than a second reference value; a case when the radio channel quality for the serving cell is worse than the first reference value and the radio channel quality for the target cell is better than the second reference value; and a case when a difference between the radio channel quality for the serving cell and the radio channel quality for the target cell satisfies a preconfigured reference value.

The operation method may further comprise, in response to satisfaction of a second condition for determining that the terminal is not able to receive the services simultaneously from the serving cell and the target cell, receiving a fifth message from the terminal.

According to the exemplary embodiments of the present disclosure, in an Xhaul network composed of wireless backhaul and fronthaul and an access link between the user terminals and the base station, efficient mobility controls and signaling procedures for the wireless terminal or user terminal, which is mounted on a moving object such as an unmanned aerial vehicle, train, autonomous vehicle, and car using a navigation device, can be provided. Therefore, in the mobile communication system, mobility support and radio link management functions for guaranteeing service continuity can be provided.

### BRIEF DESCRIPTION OF DRAWINGS

Exemplary embodiments of the present disclosure will become more apparent by describing in detail embodiments of the present disclosure with reference to the accompanying drawings, in which:

FIG. 1 is a conceptual diagram illustrating a first exemplary embodiment of a wireless communication network;

FIG. 2 is a block diagram illustrating a first exemplary embodiment of a communication node constituting a wireless communication network;

FIG. 3 is a conceptual diagram for describing a structure of a mobile communication network to which exemplary embodiments of the present disclosure are applied;

FIG. 4 is a conceptual diagram for describing in more detail a structure of a mobile communication network to which exemplary embodiments of the present disclosure are applied;

FIG. 5 is a conceptual diagram for describing an example of configuring bandwidth parts in a 3GPP NR system to which exemplary embodiments of the present disclosure are applied;

FIG. 6 is a conceptual diagram illustrating an environment to which a mobility control method according to an exemplary embodiment of the present disclosure is applied;

FIG. 7 is another conceptual diagram illustrating an environment to which a mobility control method according to an exemplary embodiment of the present disclosure is applied;

FIG. 8 is a sequence chart illustrating a conventional mobility control method;

FIG. 9 is a conceptual diagram for describing a radio environment to which a mobility control method according to an exemplary embodiment of the present disclosure is applied;

FIG. 10 is a conceptual diagram for describing another radio environment to which a mobility control method according to an exemplary embodiment of the present disclosure is applied;

FIG. 11 is a sequence chart illustrating a mobility control method according to an exemplary embodiment of the present disclosure;

FIG. 12 is a sequence chart illustrating a mobility control method according to another exemplary embodiment of the present disclosure;

FIG. 13 is a sequence chart illustrating a mobility control method according to another exemplary embodiment of the present disclosure; and

FIGS. 14A to 14D are conceptual diagrams illustrating examples of a data transmission path between a mobile network and a terminal in a mobility control method according to exemplary embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

While the present disclosure is susceptible to various modifications and alternative forms, specific embodiments are shown by way of example in the drawings and described in detail. It should be understood, however, that the description is not intended to limit the present disclosure to the specific embodiments, but, on the contrary, the present disclosure is to cover all modifications, equivalents, and alternatives that fall within the spirit and scope of the present disclosure.

Although the terms “first,” “second,” etc. may be used herein in reference to various elements, such elements should not be construed as limited by these terms. These terms are only used to distinguish one element from another. For example, a first element could be termed a second element, and a second element could be termed a first element, without departing from the scope of the present disclosure. The term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directed coupled” to another element, there are no intervening elements.

The terminology used herein is for the purpose of describing particular embodiments only and is not intended to be limiting of embodiments of the present disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, parts, and/or combinations thereof, but do not preclude the presence or addition of one or more other features, integers, steps, operations, elements, parts, and/or combinations thereof.

Unless otherwise defined, all terms (including technical and scientific terms) used herein have the same meaning as commonly understood by those of ordinary skill in the art to which the present disclosure pertains. It will be further understood that terms defined in commonly used dictionaries should be interpreted as having a meaning that is consistent with their meaning in the context of the related art and will not be interpreted in an idealized or overly formal sense unless expressly so defined herein.

Hereinafter, exemplary embodiments of the present disclosure will be described in greater detail with reference to the accompanying drawings. To facilitate overall understanding of the present disclosure, like numbers refer to like elements throughout the description of the drawings, and description of the same component will not be reiterated.

A wireless communication network to which exemplary embodiments according to the present disclosure are applied will be described. The wireless communication network to which exemplary embodiments according to the present disclosure are applied is not restricted to what will be described below. That is, the exemplary embodiments according to the present disclosure may be applied to various wireless communication networks. Here, the wireless communication network may be used with the same meaning as a wireless communication system.

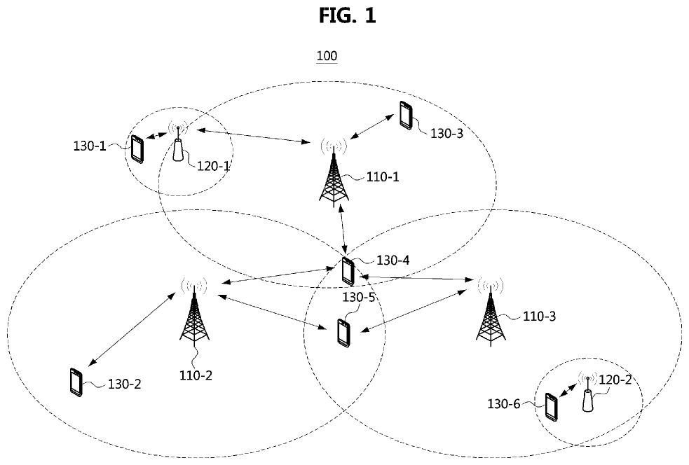

FIG. 1 is a conceptual diagram illustrating a first exemplary embodiment of a wireless communication network.

Referring to FIG. 1, a wireless communication network 100 may comprise a plurality of communication nodes 110-1, 110-2, 110-3, 120-1, 120-2, 130-1, 130-2, 130-3, 130-4, 130-5, and 130-6. Each of the plurality of communication nodes may support at least one communication protocol. For example, each of the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a space division multiple access (SDMA) based communication protocol, or the like. Each of the plurality of communication nodes may have the following structure.

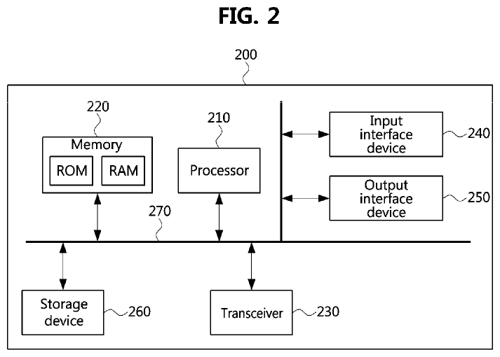

FIG. 2 is a block diagram illustrating a first exemplary embodiment of a communication node constituting a wireless communication network.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the wireless communication network 100 may comprise a plurality of base stations 110-1, 110-2, 110-3, 120-1, and 120-2, and a plurality of user equipments (UEs) 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third UE 130-3, and the fourth UE 130-4 may belong to cell coverage of the first base station 110-1. The second UE 130-2, the fourth UE 130-4, and the fifth UE 130-5 may belong to cell coverage of the second base station 110-2. Also, the fifth base station 120-2, the fourth UE 130-4, the fifth UE 130-5, and the sixth UE 130-6 may belong to cell coverage of the third base station 110-3. The first UE 130-1 may belong to cell coverage of the fourth base station 120-1. The sixth UE 130-6 may belong to cell coverage of the fifth base station 120-2.

Here, each of the plurality of base stations 110-1, 110-2, 110-3, 120-1 and 120-2 may refer to a node B (NodeB), an evolved NodeB (eNB), a base transceiver station (BTS), a radio base station, a radio transceiver, an access point, an access node, or the like. Each of the plurality of UEs 130-1, 130-2, 130-3, 130-4, 130-5 and 130-6 may refer to a terminal, an access terminal, a mobile terminal, a station, a subscriber station, a mobile station, a portable subscriber station, a node, a device, or the like.

Each of the plurality of communication nodes 110-1, 110-2, 110-3, 120-1, 120-2, 130-1, 130-2, 130-3, 130-4, 130-5, and 130-6 may support a cellular communication (e.g., long term evolution (LTE), LTE-A (advanced), etc. defined in the 3rd generation partnership project (3GPP) standard), or wireless protocol specifications of mmWave (e.g., 6 GHz to 80 GHz band) based wireless access technology. Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network (not shown) through the ideal or non-ideal backhaul. Each of the plurality of base stations 110-1, 110-2, 110-3, 120-1, and 120-2 may transmit a signal received from the core network to the corresponding UE 130-1, 130-2, 130-3, 130-4, 130-5, or 130-6, and transmit a signal received from the corresponding UE 130-1, 130-2, 130-3, 130-4, 130-5, or 130-6 to the core network.

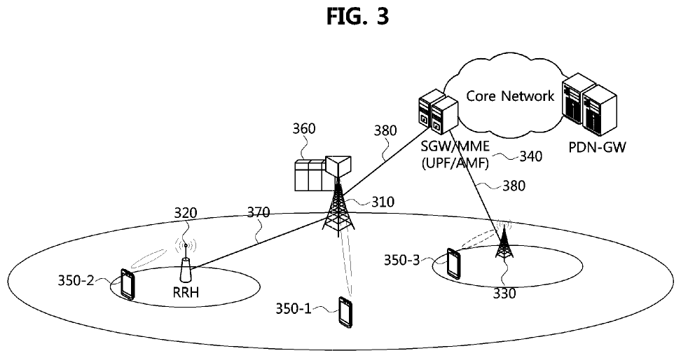

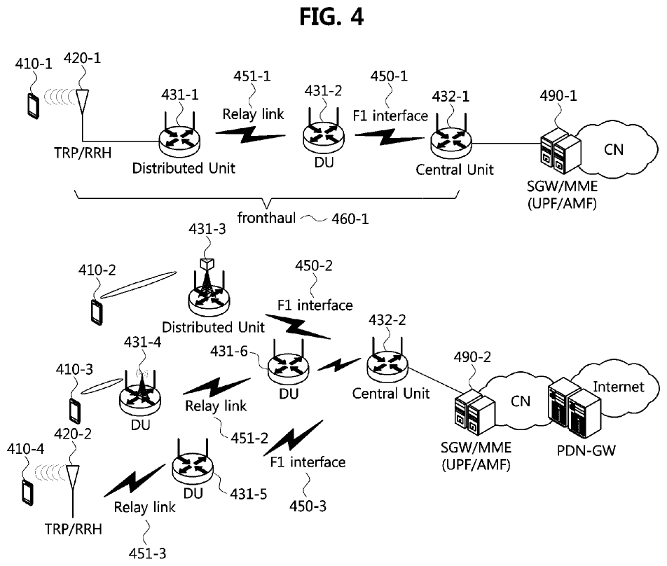

FIG. 3 is a conceptual diagram for describing a structure of a mobile communication network to which exemplary embodiments of the present disclosure are applied, and FIG. 4 is a conceptual diagram for describing in more detail a structure of a mobile communication network to which exemplary embodiments of the present disclosure are applied.

Referring to FIG. 3, an exemplary embodiment of a method of connecting a base station and a core network in a mobile communication network using fronthaul and backhaul is shown. In a cellular communication network, a base station 310 (or macro base station) or a small base station 330 may be connected to a termination node 340 of the core network by a wired backhaul 380.

Here, the termination node 340 of the core network may be a Serving Gateway (SGW), a User Plane Function (UPF), a Mobility Management Entity (MME), an Access and Mobility Function (AMF), or the like.

In addition, when base station functions are configured as split into a baseband processing function block 360 (e.g., a baseband unit (BBU) or a cloud platform) and a remote radio transmission and reception node 320 (e.g., a remote radio head (RRH) or a transmission & reception point (TRP)), the baseband processing function block 360 and the remote radio transmission and reception node 320 may be connected through a wired fronthaul 370.

The baseband processing function block 360 may be located at the base station 310 that supports a plurality of remote radio transmission and reception nodes 320 or may be configured as a logical function between the base station 310 and the termination node 340 of the core network to support multiple base stations. In this case, functions of the baseband processing function block 360 may be physically configured independently of the base station 310 and the termination node 340 of the core network, or may be installed and operated at the base station 310 (or the termination node 340 of the core network).

Each of the remote radio transmission and reception nodes 320, 420-1, and 402-2 of FIGS. 3 and 4, and each of the base stations 110-1, 110-2, 110-3, 120-1, 120-2, 310, 330, 431-3, and 431-4 of FIGS. 1, 3, and 4 may support OFDM, OFDMA, SC-FDMA, or NOMA based downlink transmission and uplink transmission with terminals.

In addition, when the remote radio transmission and reception nodes of FIGS. 3 and 4 and the plurality of base stations of FIGS. 1, 3, and 4 support a beamforming function using an antenna array in a transmission carrier of a mmWave band, services may be provided without interference between beams within the base station through the respectively formed beams, and services for a plurality of terminals (or user equipments (UEs)) may be provided within one beam.

In addition, each of the plurality of base stations 110-1, 110-2, 110-3, 120-1, 120-2, 310, 330, 471, and 472 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communication (or, proximity services (ProSe)), or the like. Here, each of the plurality of UEs 130-1, 130-2, 130-3, 130-4, 130-5, 130-6, 410-1, 410-2, 410-3, and 410-4 may perform operations corresponding to the operations of the plurality of base stations 110-1, 110-2, 110-3, 120-1, and 120-2, and operations supported by the plurality of base stations 110-1, 110-2, 110-3, 120-1, 120-2, 310, 330, 431-3, and 431-4. For example, the second base station 110-2 may transmit a signal to the fourth UE 130-4 in the SU-MIMO manner, and the fourth UE 130-4 may receive the signal from the second base station 110-2 in the SU-MIMO manner. Alternatively, the second base station 110-2 may transmit a signal to the fourth UE 130-4 and fifth UE 130-5 in the MU-MIMO manner, and each of the fourth UE 130-4 and fifth UE 130-5 may receive the signal from the second base station 110-2 in the MU-MIMO manner. Each of the first base station 110-1, the second base station 110-2, and the third base station 110-3 may transmit a signal to the fourth UE 130-4 in the CoMP transmission manner, and the fourth UE 130-4 may receive the signal from the first base station 110-1, the second base station 110-2, and the third base station 110-3 in the CoMP manner. Each of the plurality of base stations 110-1, 110-2, 110-3, 120-1, and 120-2 may exchange signals with the corresponding UEs 130-1, 130-2, 130-3, 130-4, 130-5, or 130-6 which belongs to its cell coverage in the CA manner. Each of the base stations 110-1, 110-2, and 110-3 may coordinate D2D communications between the fourth UE 130-4 and the fifth UE 130-5, and thus the fourth UE 130-4 and the fifth UE 130-5 may perform the D2D communications under coordination of each of the second base station 110-2 and the third base station 110-3.

Hereinafter, operation methods of communication nodes in a mobile communication network will be described. Even when a method (e.g., transmission or reception of a signal) to be performed in a first communication node among communication nodes is described, a corresponding second communication node may perform a method (e.g., reception or transmission of the signal) corresponding to the method performed in the first communication node. That is, when an operation of a terminal is described, a corresponding base station may perform an operation corresponding to the operation of the terminal. Conversely, when an operation of the base station is described, the corresponding terminal may perform an operation corresponding to the operation of the base station.

In the following description, the SGW is a termination node of a core network for exchanging data packets with a base station providing services to a user terminal using a radio access protocol. Also, the MME is an entity in charge of a control function in a radio access section (or interface) for user terminals in a wireless communication network. Thus, in the following description, the present disclosure is not limited to the specific terms SGW′ or ‘MME’. That is, the above-described terms may be replaced with other terms indicating a function that supports a radio access protocol according to a radio access technology (RAT) or an entity that performs the corresponding function according to a configuration of the core network.

Referring to FIG. 4, an exemplary embodiment of a configuration of a radio link between nodes to which functional split is applied is shown. When the functional split is applied, a node of a radio access network may be classified into a central unit (CU) and a distributed unit (DU).

The CU 432-1 or 432-2 (e.g., gNB-CU in the 3GPP-based NR systems) is a logical node that controls operations of one or more DUs and performs radio resource control (RRC), service data adaptation protocol (SDAP), or packet data convergence protocol (PDCP) functions according to an RRC protocol and a PDCP protocol.

The DU 431-1, 431-2, 431-3, 431-4, 431-5, or 431-6 (e.g., gNB-DU in the NR system) may be a logical node that performs functions of a radio link control (RLC) layer, a medium access control (MAC) layer, and a PHY layer, or partial functions of the PHY layer. One DU may support one or more cells, and one cell may support only one DU. The operation of the DU may be partially controlled by the CU, and the DU may be connected to the CU through an F1 interfaces 450-1, 450-2, or 450-3.

In addition, a DU (e.g., 431-2 or 431-6) for relaying may be present in a connection section between the DUs 431-1 and 431-4 and the CUs 432-1 and 432-2 according to configuration, roles, or properties of the nodes for the functional split. In this case, the interfaces between the DUs 431-1 and 431-4 and the DUs 431-2 and 431-6 may be connected through relay links 451-1 and 451-2. In addition, the DU 431 may be connected with the TRPs (or RRHs) 420-1 and 420-2 in a wired or wireless manner, or may be configured as integrated in the base stations 431-3 and 431-4.

Meanwhile, in the 3GPP NR system using the millimeter frequency band, a bandwidth part (BWP) concept is applied to secure flexibility of channel bandwidth operation for packet transmission. The base station may configure up to four BWPs having different bandwidths to the terminal. The BWPs may be configured independently for downlink and uplink. Each BWP may have not only a different bandwidth but also a different subcarrier spacing (SCS).

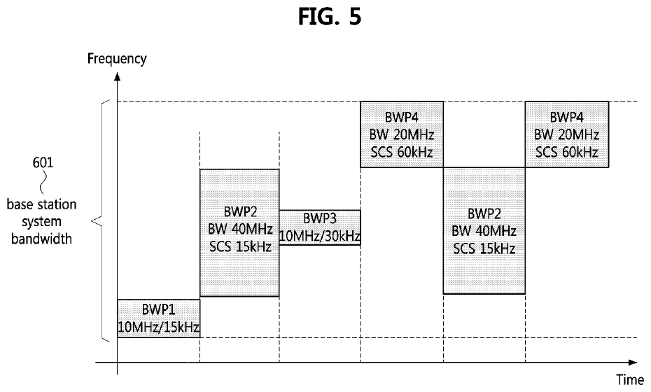

FIG. 5 is a conceptual diagram illustrating an example of configuring bandwidth parts in a 3GPP NR system to which exemplary embodiments of the present disclosure are be applied.

As shown in FIG. 5, a BWP is a bandwidth configured for transmission and reception of the terminal. The BWPs (i.e., BWP1, BWP2, BWP3, and BWP4 of FIG. 5) may be configured not to be larger than a system bandwidth 601 supported by the base station.

For example, BWP1 is configured with 10 MHz bandwidth having 15 kHz SCS, BWP2 is configured with 40 MHz bandwidth having 15 kHz SCS, BWP3 is configured with 10 MHz bandwidth having 30 kHz SCS, and BWP4 is configured with 20 MHz bandwidth having 60 kHz SCS.

The BWP may be classified into an initial BWP, an active BWP, or an optional default BWP. The terminal may perform an initial access procedure with the base station using the initial BWP. One or more BWPs may be configured through an RRC connection configuration message, and one of them may be configured as the active BWP. The terminal and the base station may transmit or receive data packets using the active BWP among the configured BWPs, and the terminal may perform a control channel monitoring operation for packet transmission and reception with respect to the active BWP.

In addition, the terminal may switch from the initial BWP to the active BWP or the default BWP, or may switch from the active BWP to the initial BWP or the default BWP. Such the BWP switching may be performed based on an indication of the base station or a timer. The indication of the base station for switching the BWP may be transmitted to the terminal using RRC signaling or a DCI of a physical downlink control channel, and the terminal may switch to the BWP indicated by the received RRC signaling or DCI. For example, in the NR system, when an RA resource is not configured in the active UL BWP, the terminal may switch from the active UL BWP to the initial UL BWP in order to perform a random access procedure.

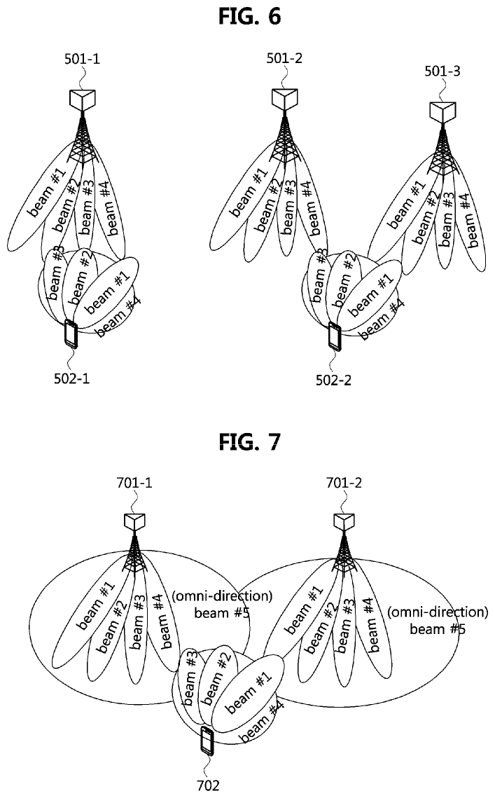

FIG. 6 is a conceptual diagram illustrating an environment to which a mobility control method according to an exemplary embodiment of the present disclosure is applied.

Referring to FIG. 6, a case in which a beamforming function is applied between the base station and the terminal is shown. In the following description, it is assumed that a signal transmitted by the base station is used to provide an inter-base station mobility function or to select an optimal beam within the base station. However, a signal transmitted by the terminal may be used for the purpose.

In FIG. 6, the terminal 502-1 or 502-2 may be in a state of establishing a connection with the base station 501-1, 501-2, or 501-3 and receiving services from the base station, in a state of establishing a connection with the base station 501-1, 501-2, or 501-3, or in a state of existing within a service coverage of the corresponding base station without establishing a connection therewith.

In a mobile communication system using a base station to which beamforming techniques are applied in a high frequency band, a function of changing a beam configured between the base station and the terminal 502-1 in the base station 501-1, and a mobility support and radio resource management function of changing beams configured between the terminal 502-2 and the base stations 501-2 and 501-3 may be considered.

For example, when a beam #3 of the base station 501-1 and a beam #2 of the terminal 502-1 are configured (or, beam paired), and services are provided by the base station 501-1, according to a change of radio channel quality, the beam used between the base station 501-1 and the terminal 502-1 may be changed from the beam #3 of the base station to another beam (e.g., beam #2 or beam #4) of the base station. Alternatively, the beam used between the base station 501-1 and the terminal 502-1 may be changed from the beam #2 of the terminal to another beam (e.g., beam #3, beam #1, or beam #4) of the terminal.

Meanwhile, the terminal 502-2, which has configured a beam with the base station 501-2, may perform a mobility support and radio resource management function based on a handover procedure, which changes the beam currently in use to a beam of the adjacent base station 501-3 according to a change in radio channel quality.

In order to perform the mobility support and radio resource management function, the base station may transmit a synchronization signal or a reference signal for the terminal to search or monitor. In case of a base station using a frame format supporting a plurality of symbol lengths to support multi-numerology, monitoring by the terminal may be performed for a synchronization signal or a reference signal configured with an initial numerology, default numerology, or default symbol length.

Here, the initial numerology or the default numerology may be a configuration of a frame format applied to radio resources in which a UE-common search space is configured, a frame format applied to radio resources in which a control resource set (CORESET) ZERO (or, CORESET #0) of physical downlink control channels of the 3GPP new radio access technology (New RAT, NR) system is configured, or a frame format applied to radio resources through which a synchronization symbol burst for identifying a cell in the 3GPP NR system is transmitted.

Here, the frame format may refer to information on configuration parameters (e.g., values of the configuration parameters, offset, index, identifier, range, periodicity, or interval (or, duration), etc.) such as a subcarrier spacing (SCS) configuring a radio frame (or subframe), a control channel configuration (e.g., configuration of CORESET), a symbol (or slot) configuration, a reference signal configuration, or the like. The information on the frame format may be transferred to the terminal using system information or a dedicated control message.

In addition, the terminal, which has configured a connection with the base station, may perform a beam management operation by monitoring a configured beam or an activated beam through transmission of an uplink dedicated reference signal configured by the base station or reception of a downlink dedicated reference signal configured by the base station.

For example, the base station 501-1 may transmit a synchronization signal (SS) and/or a downlink reference signal so that terminals in its service coverage can search for itself to perform downlink synchronization maintenance, beam configuration, or radio link monitoring operations. Also, the terminal 502-1, which has configured a connection with the serving base station 501-1, may receive physical layer radio resource configuration information for connection configuration and radio resource management from the serving base station.

Here, the physical layer radio resource configuration information may mean configuration parameters in RRC control messages of the LTE or NR system such as PhysicalConfigDedicated, PhysicalCellGroupConfig, PDCCH-Config, PDCCH-PDCCH-ConfigSIB1, ConfigCommon, PUCCH-Config, RACH-ConfigCommon, RACH-ConfigDedicated, RadioResourceConfigCommon, RadioResourceConfigDedicated, ServingCellConfig, ServingCellConfigCommon, or the like, and may include the following information. The configuration information may include parameter values such as a configuration (or allocation) periodicity of a corresponding signal (or radio resource) based on a frame format of a base station (or transmission frequency), position information of a radio resource for transmission in a time domain/frequency domain, a transmission (or allocation) time, or the like. Here, the frame format of the base station (or transmission frequency) may mean a frame format having a plurality of symbol lengths according to a plurality of SCS within one radio frame to support multi-numerology. That is, the number of symbols constituting mini-slots, slots, and subframes that exist within one radio frame (e.g., a frame of 10 ms) may be configured differently.

(1) Configuration information of transmission frequency and frame format of base station
Transmission frequency information: information on all transmission carriers (i.e., cell-specific transmission frequency) in the base station, information on BWPs in the base station, information on a transmission time reference or time difference between transmission frequencies in the base station (e.g., transmission periodicity or offset parameter indicating the transmission reference time (or time difference) of the synchronization signal), etc.
Frame format information: configuration parameters of a mini-slot, slot, subframe that supports a plurality of symbol lengths according to SCS.

(2) Configuration information of downlink reference signal (e.g., channel state information-reference signal (CSI-RS), common reference signal (Common-RS), etc.)
Configuration parameters such as a transmission periodicity, a transmission position, a code sequence, or a masking (or scrambling) sequence for a reference signal commonly applied in the coverage of the base station (or beam).

(3) Configuration information of uplink control signal
Configuration parameters such as a sounding reference signal (SRS), uplink beam sweeping (or beam monitoring) reference signal (RS), uplink grant-free radio resources, or uplink radio resources (or RA preamble) for random access, etc.

(4) Configuration information of physical downlink control channel (PDCCH)
Configuration parameters such as a reference signal for PDCCH demodulation, a beam common reference signal (e.g., a reference signal that can be received by all terminals in a beam coverage), a beam sweeping (or beam monitoring) reference signal, a reference signal for channel estimation, etc.

(5) Configuration information of physical uplink control channel (PUCCH)

(6) Scheduling request signal configuration information

(7) Configuration information for a feedback (ACK or NACK) transmission resource for supporting HARQ functions, etc.

(8) Number of antenna ports, antenna array information, beam configuration or beam index mapping information for application of beamforming techniques

(9) Configuration information of downlink and/or uplink signals (or uplink access channel resource) for beam sweeping (or beam monitoring)

(10) Configuration information of parameters for beam configuration, beam recovery, beam reconfiguration, or radio link re-establishment operation, a beam change operation within the same base station, a reception signal of a beam triggering handover execution to another base station, timers controlling the above-described operations, etc.

In case of a radio frame format that supports a plurality of symbol lengths for supporting multi-numerology, the configuration (or allocation) periodicity of the parameter constituting the above-described information, the time-domain and frequency-domain position information of the radio resource, or the transmission (or allocation) time may be information configured for each corresponding symbol length (or subcarrier spacing).

In the following description, ‘Resource-Config information’ may refer to a control message for radio resource configuration including at least one parameter among the above-described physical layer radio resource configuration information. In the following description, a property or setting value (or range) of an information element (or parameter) transmitted by the corresponding control message may have a meaning, rather than the name of ‘Resource-Config information’. Thus, the information element (or parameter) conveyed by the Resource-Config control message may be radio resource configuration information which is commonly applied to the entire base station (or beam) coverage or dedicatedly allocated to a specific terminal (or terminal group). The configuration information of the above-described Resource-Config information may be configured as one control message or may be configured as different control messages according to the property of the configuration information. In addition, the beam index may be represented without distinction between transmission beam indexes and reception beam indexes by using an index (or identifier) of a reference signal mapped or associated with the corresponding beam, or an index (or identifier) of a transmission configuration indicator (TCI) state for beam management.

Therefore, the terminal 502-1 in the connected state may be provided with services through a beam configured with the base station 501-1. For example, when the beam #3 of the base station 501-1 and the beam #2 of the terminal 502-1 are configured (or beam paired) for the terminal to receive services, the terminal 502-1 may search or monitor a downlink radio channel by using a downlink synchronization signal (e.g., a synchronization signal block (SSB) of the 3GPP NR system) and a downlink reference signal (e.g., CSI-RS of the NR system) of the beam #3 of the base station. Here, that the beams are configured (or beam paired) and services are provided may mean that packets are transmitted or received through an activated beam among one or more configured beams. In the 3GPP NR system, activation of a beam may mean that a configured TCI state is activated.

In addition, when the terminal 502-1 is in an idle state or an inactive state, the terminal 502-1 may search for or monitor a downlink radio channel using parameters obtained or configured from the system information or common Resource-Config information. Further, the terminal 502-1 may attempt access or transmit control information using an uplink channel (e.g., a random access channel or a physical layer uplink control channel).

Through such the radio link monitoring (RLM) operation, the terminal 502-1 may detect a radio link problem. Here, the detection of a radio link problem means that there is an error in configuring or maintaining physical layer synchronization for the corresponding radio link. That is, this means that it is detected that the physical layer synchronization of the terminal has not been maintained for a certain time. When a radio link problem is detected, a radio link recovery operation may be performed. If the radio link problem is not recovered, a radio link failure (RLF) may be declared, and a radio link re-establishment procedure may be performed.

A physical layer (Layer 1 or physical layer), Layer 2 functions such as Medium Access Control (MAC), Radio Link Control (RLC), Packet Data Convergence Protocol (PDCP), etc., or Layer 3 functions such as Radio Resource Control (RRC) of the radio protocol constituting the radio link may participate in the procedures such as the detection of a physical layer problem in a radio link, the radio link recovery, the radio link failure detection (or declaration), and the radio link re-establishment according to the radio link monitoring operation.

The physical layer of the terminal may receive a downlink synchronization signal and/or a reference signal (RS) to monitor the radio link. In this case, the reference signal may be a base station common reference signal (Common RS) or a beam common reference signal, or a dedicated reference signal allocated to the terminal (or terminal group). Here, the common reference signal refers to a reference signal that can be received by all terminals within the coverage (or service area) of the corresponding base station or beam to estimate a channel. In addition, the dedicated reference signal refers to a reference signal that can be received and used for channel estimation only by a specific terminal or terminal group within the coverage of the base station or the beam.

Therefore, when the base station or the configured beam is changed, the dedicated reference signal for managing the changed beam may be changed. This means that a procedure for selecting another beam from among the beams configured through the configuration parameters between the base station and the terminal or changing the configured beam is required. In the 3GPP-based NR system, changing the beam means that an index of another TCI state is selected among the indexes (or identifiers) of the configured TCI states or a new TCI state is configured and changed to an active state. Configuration information on the common reference signal may be obtained by the terminal through system information. Alternatively, in case of a handover in which the base station is changed or in case of connection reconfiguration, the base station may transmit the configuration information on the common reference signal to the terminal through a dedicated control message.

In order to provide service continuity between the base station and the terminal, a method in which the terminal provides services by allocating a plurality of beams to one terminal may be considered. For example, in FIG. 6, the base station 501-1, 501-2, or 501-3 may allocate a plurality of beams to the terminal 502-1 or 502-2. That is, the base station 501-1 may allocate the beam #2, the beam #3, and the beam #4 to the terminal 502-1. Alternatively, the base station 501-2 may allocate the beam #3 and the beam #4 to the terminal 502-2.

In this case, the plurality of beams may be allocated in consideration of moving speed, moving direction, location information, radio channel quality, or beam interference of the corresponding terminal. For example, when the moving speed of the terminal 502-1 is slow, the base station 501-1 may allocate the beams #2 and #3 adjacent to each other to the terminal 502-1. However, when the moving speed of the terminal 502-1 is fast, the base station 501-1 may allocate the beams #2 and #4 to the terminal 502-1, which are not adjacent to each other and are separated from each other.

When the terminal 502-2 moves to the base station 501-3 while receiving services by being allocated the beams #3 and #4 from the base station 501-2, if the base station 501-2 and the base station 501-3 are base stations belonging to different cells (or sectors), the terminal 502-2 may perform a handover procedure. During the handover, the terminal 502-2 may receive information on the configuration of the beams #1 and #2 of the base station 501-3 from the base station 501-2 through a handover control message. Meanwhile, the information on the beams #1 and #2 may be obtained by the base station 501-2 through a procedure in which the terminal 502-2 reports measurement results for the target/neighbor base station 501-3 to the base station 501-2.

In this case, the information on configuration of the beams may include at least one of index information of a transmission or reception beam configured according to a beam monitoring or beam measurement result, configuration information (e.g., transmission power, beam width, vertical/horizontal angle, etc.) of the corresponding beam, transmission or reception timing information (e.g., index, offset value, or the like of subframe, slot, mini-slot, symbol, etc.) of the corresponding beam, configuration information of a reference signal of the corresponding beam, and sequence information or index information of a reference signal of the corresponding beam.

In order to allocate a plurality of beams as described above, the plurality of beams allocated between the base stations 501-2 and 501-3 and the terminal 502-2, and the moving state (moving speed, moving direction, location information, etc.) of the terminal, the beam monitoring and measurement results, etc. may be reported or transferred as included in a signaling control message for performing the handover.

In addition, when the terminal 502-2 moves to the base station 501-3 while receiving services by being allocated the beams #3 and #4 from the base station 501-2, if the base station 501-2 and the base station 501-3 are base stations belonging to the same cell (or sector), an intra-cell transmission node change procedure may be performed. Here, the base station 501-2 and the base station 501-3 may be nodes (e.g., RRH, TRP, node to which a radio protocol functional split is applied, etc.) in which the radio protocols such as physical layer, MAC layer, RLC layer, PDCP layer, adaptation layer, or RRC layer, which constitute a radio access network, are partially configured. In this case, the adaptation layer (e.g., service data adaptation protocol (SDAP) layer of the NR system) is a layer higher than the PDCP, and performs functions such as mapping between a QoS flow and a data radio bearer (DRB) or marking of a QoS flow identifier for downlink (or uplink) packets.

As such, in the base stations belonging to the same cell, when the radio protocol layers for the radio access network are partially configured excluding the RRC layer, a base station change procedure from the base station 501-2 to the base station 501-3 for the terminal 502-2 may be performed through the exchange of control messages of the MAC layer (e.g., MAC control element (CE) or control PDU) without exchanging control messages of the RRC layer.

That is, which layer of the radio protocol layers is responsible for generating and transmitting/receiving the control messages for the base station change may be determined according to up to which of the radio protocol layers for the radio access network the corresponding base station (e.g., 501-2 or 501-3 of FIG. 6) is configured to include.

For example, if the base station 501-2 and the base station 501-3 are configured to include the MAC layer (or RLC layer), the control messages for the base station change may be generated at a higher layer than the MAC layer (or RLC layer), and transmitted or received between the terminal and the base station, and the MAC function (or, MAC function and RLC function) of the terminal and the base station should be newly configured after being reset.

However, when the base station 501-2 and the base station 501-3 are configured to include only a part of the MAC layer or are configured only with physical layer functions, the control messages for the base station change may be generated in the MAC layer, and transmitted or received between the terminal and the base station, and the base station change may be performed without resetting the MAC function of the terminal and the base station.

When the change of the base station (or transmission node) described above occurs, information for identifying the corresponding transmitting base station may be transferred to the terminal by using a control message of the RRC layer or the MAC layer, or a physical layer control channel according to configuration conditions of the radio protocol layers of the base station (e.g., 501-2, 501-3). In this case, the information for identifying the transmitting base station (or transmission node) may include an identifier of the base station (or transmission node), reference signal information, information on a configured beam (or configured TCI state), information on a sequence (or scrambling) identifier for the base station (or transmission node), or the like.

The reference signal information may be a radio resource of a reference signal allocated for each transmitting base station, sequence information or index information of the reference signal, or sequence information or index information of a dedicated reference signal allocated to the terminal. Here, the radio resource of the reference signal may mean parameters indicating a symbol position on a time axis at which the reference signal is transmitted and a relative or absolute subcarrier position on a frequency axis within a radio resource region such as a frame, subframe, or slot. Such the parameter may be represented by a number or the like sequentially assigned to index, symbol, or subcarrier, which represents a corresponding radio resource element or radio resource set. Hereinafter, the reference signal information may refer to the above-described transmission periodicity, the code sequence or masking (or scrambling) of the reference signal, the radio resource of the reference signal, index information, or the like. The reference signal identifier may refer to a parameter (e.g., resource ID, resource set ID) that can distinguish the corresponding reference signal information uniquely among one or more reference signal information.

The information on the configured beam may be an index (or identifier) of the configured beam (or configured TCI state), configuration information of the corresponding beam (e.g., transmission power, beam width, vertical/horizontal angle, etc.), transmission or reception timing information (e.g., an index or an offset value of subframe, slot, mini-slot, symbol, etc.) of the corresponding beam, or reference signal information or reference signal identifier information corresponding to the corresponding beam.

In addition, the base station may be installed in the air such as a drone, an aircraft, or a satellite to perform the operation of the base station described in the present disclosure.

Accordingly, the terminal may identify a target base station (or transmission node) to perform a beam monitoring operation, a radio access operation, or a transmission/reception operation of a control (or data) packet by using identification information of the transmitting base station (or transmission node), which the base station transmits using the control message of the RRC layer or the MAC layer, or the physical layer control channel.

In the case where a plurality of beams are configured, the base station and the terminal may transmit and receive packet information with all the configured beams, and the number of downlink beams may be the same as or different from the number of uplink beams. For example, a plurality of downlink beams from the base station to the terminal may be configured, and one uplink beam from the terminal to the base station may be configured.

Alternatively, when a plurality of beams are configured, the base station and the terminal may not transmit and receive packet information with all the configured beams, and some of the configured plurality of beams may be configured as reserved (or candidate) beam(s) not for transmitting and receiving packet information. For example, the configured plurality of beams may be configured in form of primary beam, secondary beam, or reserved (or candidate) beam(s). In the NR system, such the configuration of the plurality of beams may mean that the configured TCI state identifiers (IDs) are configured in form of primary, secondary, or reserved.

For example, the primary beam (e.g., primary TCI state ID) may mean a beam capable of transmitting and receiving data and control signaling, and the secondary beam (e.g., secondary TCI state ID or deactivated TCI state ID) may mean a beam capable of transmitting and receiving only data packets excluding control signaling. Here, the exclusion of the control signaling may be performed by a method of restricting the control signaling of physical layer, layer 2 (e.g., layer 2 such as MAC, RLC, PDCP, etc.), or layer 3 (e.g., layer 3 such as RRC, etc.) according to each layer, a method of partially restricting them according to functions within the layer, or a method of restricting them according to the type of the control message. However, the type of control message may mean a type of control message generated or transmitted/received according to operational functions of the radio protocol such as discontinuous transmission/reception (DRX/DTX) operations, retransmission operations, connection configuration and management operations, measurement/reporting operations, operations of a paging procedure, operations of an access procedure, etc.

In addition, the reserved (or candidate) beam (e.g., reserved TCI sate ID or deactivated TCI state ID) may be limited in transmission and reception of data or signaling packets. Also, the reserved (or candidate) beam may be configured as a beam on which the base station or the terminal performs only beam monitoring operations for beam matching (or configuration) or performs only measurement and reporting operations. Accordingly, measurement results for the reserved (or candidate) beam may be reported using the primary beam or the secondary beam. The measurement or reporting on the reserved (or candidate) beam may be performed in accordance with a related configuration parameter or periodically or aperiodically in accordance with a determination or event condition of the terminal. In particular, the report of the results of measurement or beam monitoring on the reserved (or candidate) beam may be transmitted using a physical layer control channel, such as a physical uplink control channel (PUCCH) of the LTE (or NR) system, or a control message of the MAC layer (e.g., a form such as MAC control PDU). Here, the result of the beam monitoring may refer to measurement results of one or more beams (or beam groups) as results of the beam monitoring (or beam sweeping) operation on the formed beam of the base station, which is performed by the terminal.

Based on the report of results of beam measurement or beam monitoring, the base station may change the property (e.g., primary beam, secondary beam, reserved (or candidate) beam, active beam, or deactivated beam) of the beam (or property of the TCI state). Here, when the TCI state is changed, the property of the TCI state may be changed to a primary TCI state, a secondary TCI state, a reserved (or candidate) TCI state, a configured TCI state, an active TCI state, a deactivated TCI state, or the like.

As described above with respect to the property of the TCI state, a state in which a data packet or control signaling can be transmitted or received even in a limited manner, such as the primary TCI state or the secondary TCI state, may be assumed as the active TCI state or a serving TCI state. Also, a state in which it is a target of measurement or management, but data packets or control signaling cannot be transmitted or received, such as the reserved (or candidate) TCI state, may be assumed as the deactivated TCI state or configured TCI state.

The change of the property of the beam (or TCI state) may be controlled at the RRC layer or the MAC layer. When changing the property of a beam (or TCI state) at the MAC layer, the MAC layer may notify the higher layer of the beam property change. In addition, the change of beam property may be transferred to the terminal using a control message of the MAC layer or a physical layer control channel (e.g., a physical downlink control channel (PDCCH) of the LTE (or NR) system). Here, when the physical layer control channel is used, the control information may be configured in form of downlink control information (DCI), uplink control information (UCI), or a separate indicator (or field information) of the LTE (or NR) system.

The terminal may request to change the TCI state property based on the beam measurement or monitoring results. The control information or feedback information for requesting the change of the TCI state property may be transmitted using a physical layer control channel, a MAC layer control message, or an RRC control message. The control message, signaling information, or feedback information for changing the TCI state property may be configured using at least one or more parameters from the above-described information on configured beam.

The property change of the beam (or TCI state) described above may mean a change from the active beam to the deactivated beam or reserved (or candidate) beam, or a change from the primary beam to the secondary beam or reserved (or candidate) beam, or vice versa. That is, it means that the property of the beam is changed between the beam properties described above, and the change of beam property may be performed in the RRC layer or the MAC layer. If necessary, the beam property change may be performed through partial cooperation between the RRC layer and the MAC layer.

In addition, when a plurality of beams are allocated, a beam for transmitting a physical layer control channel may be configured and operated. That is, a physical layer control channel may be transmitted using all the multiple beams (e.g., the primary beam or the secondary beam) or a physical layer control channel may be transmitted using only the primary beam.

Here, the physical layer control channel is a channel such as PDCCH or PUCCH of the LTE (or NR) system, and may transmit scheduling information including radio resource element (RE) allocation and modulation and coding scheme (MCS) information, channel quality indication (CQI), precoding matrix indicator (PMI), feedback information such as HARQ ACK/NACK, resource request information such as scheduling request (SR), beam monitoring result (or TCI state ID) for supporting beamforming function, measurement information on active or inactive beams, or the like.

In case that the physical layer control channel is transmitted using only a downlink primary beam transmitted from the base station to the terminal, the feedback information may be received through the physical layer control channel of the primary beam or data transmitted through the secondary beam may be demodulated and decoded using control information obtained through the physical layer control channel of the primary beam.

Alternatively, in case that the physical layer control channel is transmitted using only an uplink primary beam transmitted from the terminal to the base station, scheduling request information or feedback control information may be transmitted through the physical layer control channel of the primary beam.

In the case of the multiple beam allocation (or TCI state configuration) described above, parameters indicating allocated (or, configured) beam indexes for the multiple beams (or TCI states), spacing between the allocated beams, or whether or not contiguous beams are allocated may be transferred through signaling between the base station and the terminal. Signaling for such the beam allocation may be configured differently according to a report from the terminal such as moving speed, moving direction, or location information of the terminal, or moving state, moving speed, moving direction, and location information of the terminal, or the quality of radio channel, which the base station can recognize or obtain by other means. Here, the quality of radio channel may refer to a signal quality of a radio channel represented by a channel state indicator (CSI), a Received Signal Strength Indicator (RSSI), a Reference Signal Received Power (RSRP), a Reference Signal Received Quality (RSRQ), or the like.

In the above description, the radio resource may be configured by frequency-axis parameters such as center frequency, system bandwidth, subcarriers, or the like and time-axis parameters according to a unit of transmission (or reception) time (or, periodicity, interval, window) such as radio frame, subframe, transmission time interval (TTI), slot, mini-slot, symbol, or the like. Additionally, the radio resource may refer to a resource occupied for transmission in the radio section by applying a hopping pattern of the radio resource, a beam forming technique using multiple antennas (e.g., beam configuration information, beam index), or a code sequence (or bit sequence or signal sequence). In case of such the radio resource, the name of the physical layer channel (or transport channel) may vary according to the type (or property) of data or control message to be transmitted, uplink, downlink, sidelink (or side channel), or the like.

Such the reference signal for beam (or TCI state) or radio link management may include a synchronization signal such as a synchronization signal (SS) or a synchronization signal block (SSB), a channel state information reference signal (CSI-RS), a phase tracking (PT-RS), a sounding reference signal (SRS), a demodulation reference signal (DM-RS), or the like. A reference parameter for reception quality of the reference signal for beam (or TCI state) or radio link management may be configured as a parameter such as a measurement unit time, a measurement interval, a reference value indicating a degree of improved change, a reference value indicating a degree of deteriorated change, or the like. The measurement unit time or measurement interval may be configured as an absolute time reference (e.g., ms, sec, etc.), transmission timing interval (TTI), a radio channel configuration such as symbol, slot, (sub)frame, scheduling periodicity, etc., an operation periodicity of the base station or terminal, or the like. Also, the reference value representing the degree of change in reception quality may be configured as an absolute value (dBm) or a relative value (dB). Also, the reception quality of the reference signal for beam (or TCI state) or radio link management may be represented by Reference Signal Received Power (RSRP), Reference Signal Received Quality (RSRQ), Received Signal Strength Indicator (RS SI), Signal-to-Noise Ratio (SNR), Signal-to-Interference Ratio (SIR), or the like.

The measurement or monitoring operation for beam (or TCI state) or radio link management described above may be performed by the base station or the terminal. The base station or the terminal may perform the measurement or monitoring operation according to the parameters configured for the measurement operation or monitoring, and the terminal may report measurement results according to configuration parameters for the measurement reporting.

According to the measurement result, when the reception quality of the reference signal satisfies a predetermined reference value and/or a preconfigured timer condition, the base station may determine (or, trigger) deactivation (or activation) or the like of the beam according to the beam (or radio link) management, beam switching, or beam blockage situation, and transmit a control message indicating a related operation to the terminal.

In addition, when the reception quality of the reference signal according to the measurement result satisfies the configured reference value and/or preconfigured timer condition, the terminal may report the measurement result or may transmit a control message triggering (or requesting) deactivation (or activation) of the beam according to the beam (or radio link) management operation, beam switching (or TCI state ID change or property change), or the beam blockage situation to the base station.

The basic operation procedure for the beam (or TCI state) management through radio link monitoring may include a beam failure detection (BFD), a beam recovery (BR), or a beam failure recovery (BFR) request procedure, or the like for the radio link. The function for determining the beam failure detection or beam recovery operation and triggering the related procedures, control signaling, or the like may be performed by the physical layer, the MAC layer, the RRC layer, or the like in cooperation, or the related function may be performed by them as partially divided.

FIG. 7 is another conceptual diagram illustrating an environment to which a mobility control method according to an exemplary embodiment of the present disclosure is applied.

As shown in FIG. 7, when a terminal 707 connected to a base station 701-1 and receiving a service from the base station 701-1 moves to a cell of a base station 701-2, or due to changes in radio channels with respect to the base stations 701-1 and 701-2, a situation in which a handover or ‘reconfiguration with sync’ needs to be performed may occur. Here, a cell of the base station 701-1 may be a current serving cell for the terminal 702 and the cell of the base station 701-2 may be a target cell of a handover procedure for the terminal 702. Hereinafter, the base station 701-1 may be referred to as a serving cell or a source cell, and the base station 701-2 may be referred to as a target cell.

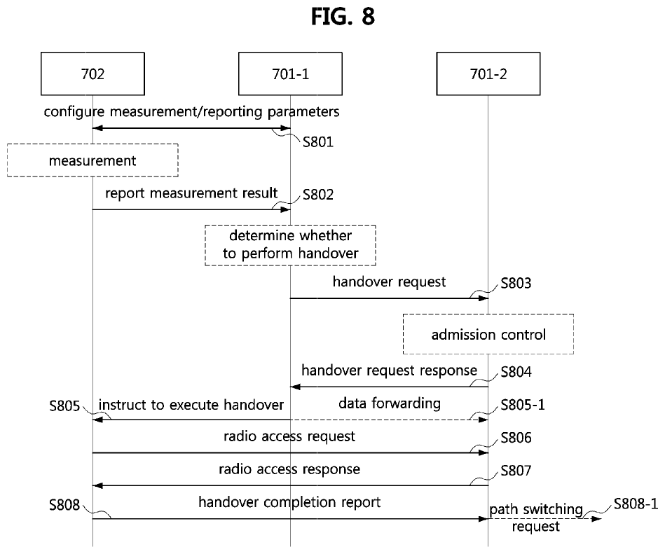

FIG. 8 is a sequence chart illustrating a conventional mobility control method.

As shown in FIG. 8, the terminal 702 may establish a connection with the serving cell 701-1 and receive a service from the serving cell 701-1. The terminal 702 may receive a control message including parameters for measurement and reporting for mobility function support from the serving cell 701-1, and configure the related parameters (S801). The terminal 702 may perform measurement on the serving cell 701-1 and the neighbor cell 701-2 according to the configured parameters (or conditions) for measurement and reporting, and may report a measurement result to the serving cell 701-1 (S802).

When the control message for reporting the measurement result for the serving cell 701-1 and/or the neighbor cell 701-2 is received from the terminal 702, the serving cell 701-1 may determine whether to perform a handover. The serving cell 701-1 having determined to perform the handover based on the control message reporting the measurement result may transmit a control message requesting the handover to the neighbor cell 701-2 determined as the target cell for the terminal 702 (S803).

The target cell 701-2 may perform admission control with respect to the corresponding terminal 702, and transmit a result (i.e., a response to the handover request) to the serving cell (S804). When the target cell 701-2 accepts the handover request from the serving cell 701-1, the control message transmitted by the target cell 701-2 to the serving cell 701-1 in the step S804 may include resource configuration information (i.e., Resource-Config information) (e.g., a scheduling identifier, random access parameters, beam configuration parameters, encryption parameters, DRX parameters, etc.) for the corresponding terminal.

Upon receiving the response message for the handover request from the target cell 701-2, the serving cell 701-1 may transmit, to the terminal 702, a control message (e.g., in case of the 3GPP NR system, control message including ‘reconfigurationWithSync’ information) instructing the terminal 702 to execute the handover (or, triggering the handover) (S805). In addition, the serving cell 701-1 may transfer necessary control information (e.g., SN status parameter, etc.) to the target cell 701-2 while transferring data for the terminal 702, which is stored in a buffer of the serving cell 701-1 (S805-1).

Upon receiving the control message instructing to execute the handover from the serving cell 701-1, the terminal 702 may use the random access parameter or the beam configuration parameter received through the message instructing to execute the handover to perform a radio access request procedure (e.g., random access or uplink transmission) to the target cell 701-2(S806). The target cell 701-2 may transmit a response message for the radio access request, a downlink message, or an uplink resource allocation message to the terminal 702 (S807).

Upon receiving the response message for the radio access request, the downlink message, or the uplink resource allocation message from the target cell 701-2, the terminal 702 may complete the handover procedure by transmitting a control message reporting the completion of the handover to the target cell 701-2 (S808).

Meanwhile, the target cell 701-2 may transmit, to a network (e.g., core network), a control message requesting to switch a path for user data traffic to the target cell (S808-1). The target cell 701-2 may perform a procedure for switching the path to the target cell 701-2 by exchanging signaling messages for switching the path to the target cell with a relevant node (e.g., AMF or UPF) of the network.

In a millimeter wave-based mobile communication system, in order to reduce transmission delay and improve transmission reliability in a radio section between the base stations and the terminal, a method in which the terminal performing handover receives services simultaneously from the source cell 701-1 and the target cell 701-2 may be considered.

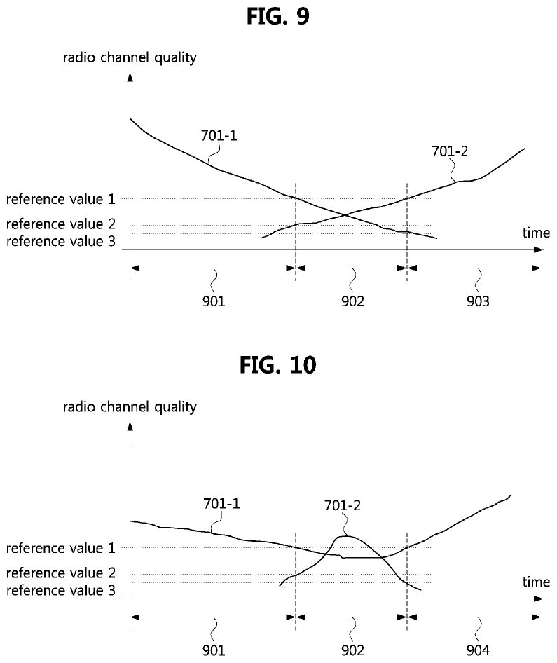

FIG. 9 is a conceptual diagram for describing a radio environment to which a mobility control method according to an exemplary embodiment of the present disclosure is applied, and FIG. 10 is a conceptual diagram for describing another radio environment to which a mobility control method according to an exemplary embodiment of the present disclosure is applied.

As shown in FIGS. 9 and 10, intervals 901, 903, or 904, in which a service is provided to the terminal 702 through a single cell (e.g., serving cell 701-1 or target cell 701-2), or an interval 902, in which services are provided to the terminal 702 simultaneously through both of the serving cell 701-1 and the target cell 701-2, may exist according to radio channel qualities for the serving cell 701-1 and the target cell 701-2.

In FIG. 9, if the target cell 701-2 has a good radio channel quality after the interval 902 in which the two cells 701-1 and 701-2 simultaneously provide the services, the interval 903 in which the service is provided only by the target cell 701-2 may exist. On the other hand, in FIG. 10, if the target cell 701-2 has a poor radio channel quality after the interval 902 in which the two cells 701-1 and 701-2 simultaneously provide the services, the interval 904 in which the service is provided only by the serving cell 701-1 may exist.

Here, the serving cell 701-1 or the target cell 701-2 may be not only a single cell providing a service using a single carrier (or a transmission frequency configured with a single system band), but also a DU according to functional split, eNB, gNB, or the like. Alternatively, the serving cell 701-1 or the target cell 701-2 may be a node supporting a carrier aggregation (CA) function using a plurality of carriers.

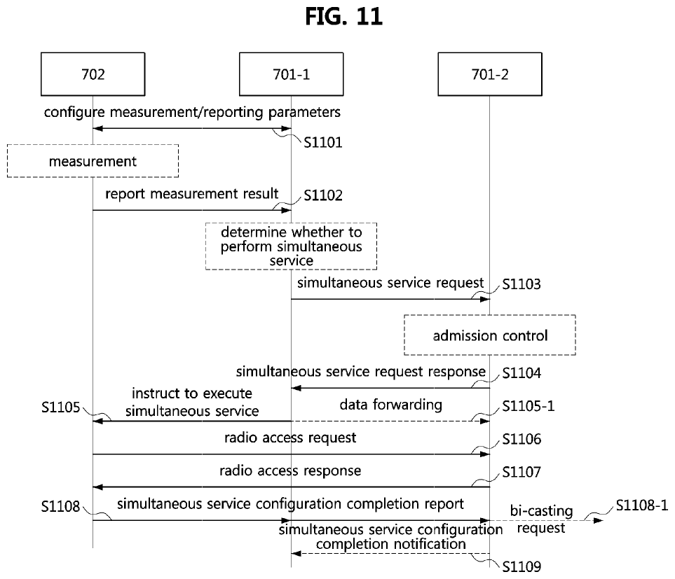

FIG. 11 is a sequence chart illustrating a mobility control method according to an exemplary embodiment of the present disclosure.

Although not shown in FIG. 11, in a procedure of establishing a connection with the serving cell 701-1 (not shown) or a procedure of registering with a network (not shown), the terminal 702 may transfer capability information to the serving cell 701-1, the capability information informing that the terminal 702 is a terminal capable of simultaneously receiving services from two cells in terms of the mobility function support. Alternatively, in the step S1101 of configuring the measurement or reporting parameters for mobility control, the terminal 702 establishing a connection with the serving cell 701-1 may report, to the serving cell 701-1, the capability information informing that the terminal 702 is a terminal capable of simultaneously receiving services from two cells.

The terminal 702 receiving the service only from the serving cell 701-1 in the interval 901 of FIG. 9 or FIG. 10 may report the measurement result to the serving cell 701-1 when one or more of the following conditions are satisfied (S1102). Which of the following conditions is to be used may be configured using a control message (e.g., the control message of S1101) or may be predefined in the technical specification.
The radio channel quality for the serving cell is worse than a reference value 1.
The radio channel quality for the target cell is better than a reference value 2.
The radio channel quality for the serving cell is worse than the reference value 1 and the radio channel quality for the target cell is better than the reference value 2.
A difference between the radio channel quality for the serving cell and the radio channel quality for the target cell (or candidate cell) satisfies a preconfigured reference value.

That is, the terminal 702 may transmit, to the serving cell, a control (or measurement result) message requesting a start (or configuration) of the simultaneous service or informing that the start (or configuration) condition of the simultaneous service is satisfied according to the preconfigured condition (S1102). The simultaneous service may mean a mobility function support scheme or a handover scheme in which the radio protocol layer functions such as PHY, MAC, RLC, PDCP, or SDAP exist independently in each of the source cell and the target cell, and related functions are performed independently for the corresponding terminal. That is, the simultaneous service is a handover scheme using radio protocol layers (or stack) dually activated in the source cell and the target cell for the handover terminal (i.e., dual active protocol layer handover or dual active protocol stack handover).

When the control message requesting the start of the simultaneous service or informing that the condition for starting the simultaneous service is satisfied is received from the terminal 702, the serving cell 701-1 may determine whether to perform the simultaneous service. As a result of the determination, the serving cell 701-1 determining to provide the simultaneous service may request the simultaneous service to the target cell 701-2 (S1103).

The target cell 701-2 may determine whether to perform the simultaneous service through admission control, and transmit a result of the determination to the serving cell (S1104). When the target cell 701-2 determines to provide the simultaneous service, the control message of the step S1104 may include resource configuration information (e.g., Resource-Config information) for the corresponding terminal 702 (e.g., scheduling identifier, random access parameters, beam configuration parameters, encryption parameters, DRX parameters, etc.).

Through the steps S1103 and S1104, for the efficient provision of the simultaneous service, the serving cell 701-1 and the target cell 701-2 may exchange the capability information of the terminal 702, physical layer radio resource configuration information, and configuration information of each layer (e.g., RRC, SDAP, PDCP, RLC, MAC, etc.) of the radio protocol, or transfer its (serving cell or target cell) configuration information to the counterpart so that the configuration information is configured as common parameters. Such the configuration information may include configuration information defined as access stratum (AS) context (or, RRC context) such as physical layer control channel, discontinuous reception (DRX) operation, various identifiers (e.g., C-RNTI), encryption information, beam (or reference signal) configuration information, and the like, or parameter information thereof, frequency band combination information, carrier aggregation/dual connectivity/MIMO configuration information, or BWP or subcarrier spacing (SCS) configuration parameters of the cell and the terminal.

Based on the response message (S1104) for the simultaneous service request received from the target cell 701-2, the serving cell 701-1 may transmit a control message instructing (e.g., triggering) to execute the simultaneous service (e.g., dual active protocol layer/stack based handover message) to the terminal 702 (S1105).

In addition, after the step S1105, the serving cell 701-1 may forward data for the terminal 702 stored in the buffer to the target cell 701-2 (S1105-1). In the step S1105-1, the serving cell 701-1 may transfer sequence number (SN) status information indicating whether data packets for the terminal 702 have been successfully delivered to the target cell 701-2. The SN status information may include information such as a sequence number of the successfully-delivered data packet and a sequence number of a data packet whose delivery has not been confirmed.

The control message of the step S1105 may further include control information for the simultaneous service provision, which is not included in the control message of the step S805 according to the conventional handover procedure described in FIG. 8. For example, the control message of the step S1105 may be include a reference condition (or threshold) of a radio channel for provision of the simultaneous service for mobility function support (e.g., handover), parameters for performing operations, a triggering condition(s), a reference value(s) (or, threshold) for measurement or reporting, a related timer configuration parameter(s), or the like. Such the configuration parameter(s) (or condition(s)) may be configuration information of the reference value 1, the reference value 2, the reference value 3, and the like, or configuration information of parameters for the simultaneous service start (or configuration) condition, the simultaneous service end (or release) condition, deactivation condition of the radio protocol layers/stack of the source cell (or target cell), connection release condition of the source cell (or target cell), or references for selecting the serving cell (or target cell). Alternatively, such the information may be previously provided to the terminal 702 using a dedicated control message in the connection establishment step with the serving cell 701-1.

The terminal 702 receiving the control message instructing to execute the simultaneous service of the step S1105 from the serving cell 701-1 may generate or activate radio protocol functions for the target cell 701-2. For example, with respect to a radio bearer (data radio bearer (DRB) or signaling radio bearer (SRB)) that is a target of the simultaneous service, a PDCP function for transmitting or receiving data to or from the target cell 701-2 may be configured on a radio bearer basis, and an RLC function may be configured on a logical channel basis. In addition, a MAC function for the target cell 701-2 may be configured to trigger a radio access procedure to the target cell 701-2.

Upon receiving the control message instructing the execution of the simultaneous service in the step S1105 from the serving cell 701-1, the terminal 702 may perform a radio access request procedure to the target cell 701-2 (S1106). In the step S1106, the terminal 702 may perform the radio access request procedure through uplink resources (e.g., configured beam, random access resources, transmission timing information, or transmission power information) obtained from Resource-Config information of the target cell 701-2 received from the serving cell 701-1. The target cell 701-2 receiving the radio access request signal (or message) from the terminal 702 through the step S1106 may transmit a radio access response message to the terminal 702 (S1107). Upon receiving the response message for the radio access request from the target cell 701-2, the terminal 702 may transmit a message reporting completion of configuration of the simultaneous service to the serving cell 701-1 (S1108).

Alternatively, when the Resource-Config information of the target cell 701-2 is delivered to the terminal 702 before the step S1105, or when the terminal 702 can obtain information on a transmission power or a transmission timing between the terminal 702 and the target cell 701-2, the terminal 702 may receive the control message of the step S1107 or a downlink data packet from the target cell 701-2 without performing the step S1106. In addition, even when the information on the transmission timing between the terminal 702 and the target cell 701-2 is not necessary, the terminal 702 may receive the control message of the step S1107 or the downlink data packet from the target cell 701-2 without performing the step S1106 for acquisition of the uplink transmission timing (or synchronization). That is, when the information on the transmission power or the transmission timing between the terminal 702 and the target cell 701-2 can be obtained or no related information is required in accordance with a predefined condition, the target cell 701-2 may transmit, to the terminal 702, the control message of the step S1107, signaling control information (e.g., control information such as DCI/UCI using a PDCCH, a MAC CE, etc.) or the downlink data packet.

In this case, the case when the information on the transmission timing between the terminal 702 and the target cell 701-2 is not necessary may include a case when the service coverage of the target cell 701-2 is small, and thus uplink timing adjustment between terminals within the target cell 701-2 is not necessary, a case of a substantially deactivated situation (e.g., when the target cell 701-2 transmits timing adjustment information set to ‘0’ to the terminal 702), or a case of a synchronous system that does not need to adjust the transmission timing with the source cell 701-1 or the target cell 701-2.

When the step S1106 can be omitted as described above, the terminal 702 may transmit a simultaneous service configuration completion report message of the step S1108 to the target cell 701-2 without performing the step S1107 of receiving the control message or the downlink data packet from the target cell 701-2. The uplink resource for this case may be allocated by the serving cell 701-1 in the step S1105. Alternatively, information on an uplink radio resource allocated by the target cell 701-2 may be delivered to the terminal 702 via the serving cell 701-1.

Alternatively, when the terminal 702 performing the step S1106 transmits feedback information (e.g., field information of a physical layer uplink control channel such as HARQ) to the target cell 701-2, or the terminal transmits packet data to the target cell 701-2 through the uplink resource allocated (or scheduled) in the step S1107, the target cell 701-2 may determine that the configuration of the simultaneous service is completed.

In addition, upon receiving the report of completion of the configuration of the simultaneous service from the terminal 702, the target cell 701-2 may transmit the corresponding information to the serving cell 701-1 (S1109), or the terminal 702 may transmit a control message indicating that the configuration of the simultaneous service is completed also to the serving cell 701-1. If the serving cell 701-1 receiving the control message indicating the completion of the simultaneous service-based handover from the target cell 701-2 or the terminal 702 did not perform a forwarding operation therefor to the target cell 710-2 in the step S1105-1, the data for the terminal 702, which is stored in the buffer of the serving cell 701-1 and SN status information may be forwarded to the target cell 701-2.

Meanwhile, the target cell 701-2 may transmit a control message requesting bi-casting or duplicate transmission of both of the serving cell and the target cell for data forwarding to the corresponding terminal to a related node (e.g., AMF, UPF, etc.) in the mobile network (e.g., core network) (S1108-1). When the data forwarding operation for the terminal 702 is performed from the serving cell 701-1 to the target cell 701-2 in the step S1105-1, the target cell 701-2 may perform the step S1108-1 of transmitting the control message requesting bi-casting or duplicate transmission subsequently from the step S1105-1.

Meanwhile, the serving cell 701-1, which has transmitted the control message of the step S1105 to the terminal 702, does not receive the control message of step S1109 from the target cell 701-2 until a preset timer (e.g., TimerA) expires, the serving cell 701-1 may recognize that the simultaneous service configuration has failed. Here, the timer TimerA may be started when the serving cell 701-1 transmits the control message of the step S1105 to the terminal 702, and may be stopped or reset when the control message of the step S1109 is received from the target cell 701-2. If the control message of the step S1109 is not received until the timer TimerA expires, the serving cell 701-1 may transmit to the corresponding terminal 702 a control message requesting a measurement result or instructing to perform a radio link re-establishment procedure or a random access procedure. In this case, the downlink control message may be transmitted using the scheduling identifier assigned to the corresponding terminal using the control message of the step S1105.

Meanwhile, the target cell 701-2, which has transmitted the control message of the step S1104 to the serving cell 701-1, may recognize that the simultaneous service configuration has failed when the radio access request of the step S1106 is not received from the terminal 702 until a preset timer (e.g., TimerB) expires. Here, the timer TimerB may be started when the target cell 701-2 transmits the control message of the step S1104 to the serving cell 701-1, and may be stopped or reset when the radio access request of the step S1106 is received from the terminal 702. The target cell 701-2, which has not received the radio access request of the step S1106 until the timer TimerB expires, may transmit to the serving cell 701-1 a control message informing that the simultaneous service configuration has failed. In addition, the serving cell 701-1 or the target cell 701-2 may transmit to the corresponding terminal 702 a control message requesting a measurement result or instructing to perform a radio link re-establishment procedure or a random access procedure. In this case, the downlink control message may be transmitted using the scheduling identifier assigned to the corresponding terminal using the control message of the step S1105.

The handover procedure described in FIG. 11 may correspond to the case where the serving cell 701-1 triggers the simultaneous service. In another exemplary embodiment, the target cell 701-2 may trigger the simultaneous service.

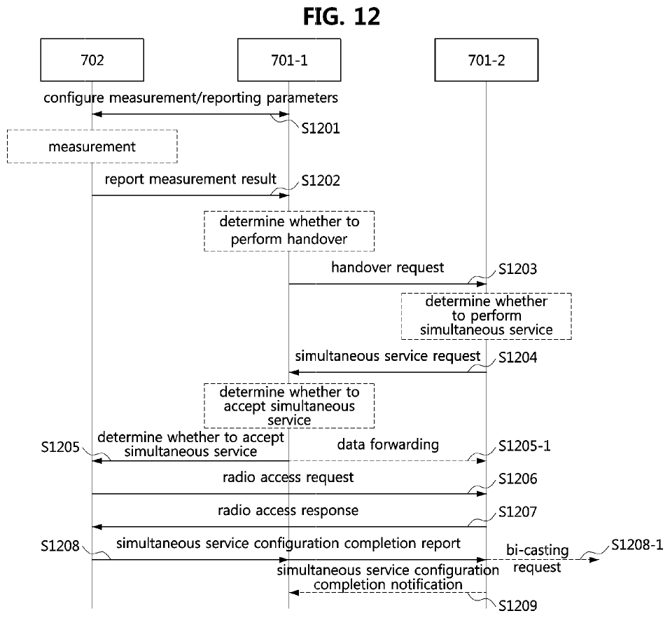

FIG. 12 is a sequence chart illustrating a mobility control method according to another exemplary embodiment of the present disclosure.

Referring to FIG. 12, steps S1201 to S1203 may be performed in the same manner as the steps S801 to S803 of the conventional handover procedure of FIG. 8. In the exemplary embodiment of FIG. 12, the target cell 701-2 may trigger the simultaneous service in the step of performing admission control. That is, when the serving cell 701-1 requests the handover of the terminal to the target cell 701-2 through the step S1203, the target cell 701-2 may determine whether to perform the simultaneous service, and may request the simultaneous service to the serving cell 701-1 (S1204). In the case, in the step S1204 (i.e., simultaneous service request step), the target cell 701-2 may transmit a message corresponding to the simultaneous service request response message of the step S1104 of FIG. 11 to the serving cell 701-1.

First, the handover request message of the step S1203 transmitted by the serving cell 701-1 to the target cell 701-2 may include at least one of the following information.
Information informing that the serving cell is capable of providing the simultaneous service triggered by the target cell
Information on the target cell, that allows the target cell to trigger the simultaneous service
Capability information of the terminal indicating whether the terminal supports the simultaneous service

Here, the information on the target cell, that allows the target cell to trigger the simultaneous service, may be measurement information on the target cell, location information of the terminal, or the like.

In addition, the serving cell 701-1 may determine whether to accept the simultaneous service triggered by the target cell 701-2. When the serving cell 701-1 accepts the simultaneous service triggered by the target cell 701-2, the serving cell 701-1 may transmit to the terminal a control message instructing execution of the simultaneous service (S1205). The control message transmitted from the serving cell 701-1 to the terminal 702 in the step S1205 may be the same as the control message of the step S1105 of FIG. 11. Thereafter, the terminal, the serving cell, and the target cell may perform a step S1205-1 and steps S1206 to S1209 in the same manner as the step S1105-1 and the steps S1106 to S1109 of FIG. 11.

On the other hand, when the serving cell 701-1 does not accept the simultaneous service triggered by the target cell 701-2, the conventional handover procedure according to the steps S805 to S808 of FIG. 8 may be performed. In addition, in the step S805 or subsequent steps, the serving cell 701-1 may transmit to the target cell 701-2 a control message indicating that the conventional handover procedure is performed without accepting the simultaneous service requested by the target cell 701-2 in the step S1204.

The target cell 701-2 may perform a step S1208-1 of FIG. 12, in which a bi-casting or duplicate transmission request control message is transmitted, after the step S1205-1. In this case, the step S1208-1 after performing the step S1208 may be omitted.

In the simultaneous service procedure according to FIGS. 11 and 12, even after receiving the S1105 message of FIG. 11 or the S1205 message of FIG. 12, the terminal 702 may receive downlink data from the serving cell 701-1 while maintaining the connection with the serving cell 701-1 until the connection with the serving cell 701-1 is released. Therefore, when the terminal 702 completes the radio access procedure with the target cell 701-2, the terminal 702 may receive downlink data from both of the serving cell 701-1 and the target cell 701-2 until the connection with the serving cell 701-1 is released. Also, when the connection establishment for the simultaneous service is completed according to the simultaneous operation procedure and the terminal 702 receives downlink data from each of the serving cell 701-1 and the target cell 701-2, security operation (e.g., encryption) may be performed independently in each PDCP layer of the serving cell 701-1 and the target cell 701-2.

The terminal 702 may transmit uplink data to the serving cell 701-1 until the connection establishment with the target cell 701-2 is completed. Even after the connection establishment with the target cell 701-2 is completed, the terminal 702 may transmit uplink data to the serving cell 701-1 until the connection with the serving cell 701-1 is released, or may transmit to the serving cell 701-1 retransmission data or retransmission related feedback information (HARQ feedback, RLC feedback information, or sequence status information, etc.) for the uplink data previously transmitted to the serving cell 701-1.

When the simultaneous service configuration has failed, the terminal 702 may report the simultaneous service configuration failure to the serving cell 701-1. For example, when the terminal 702 does not successfully complete the radio access procedure (e.g., the steps S1106 to S1107 of FIG. 11 or the steps S1206 to S1207 of FIG. 12) with the target cell 701-2, if the radio link with the serving cell 701-1 is valid, the terminal 702 may report the simultaneous service configuration failure to the serving cell 701-1.

When the simultaneous service configuration has failed, the terminal 702 may perform a connection re-establishment procedure. In order to perform the connection re-establishment procedure, the terminal 702 may perform a cell search operation, and a target of the connection re-establishment may be the serving cell 701-1, the target cell 701-2, or another cell according to a result of the cell search operation. When the target with which the terminal completes the connection re-establishment procedure is not the serving cell 701-1 or the target cell 701-2, the terminal 702 may report, to a cell to which the terminal 702 is connected through the connection re-establishment, cell identification information of the serving cell 701-1 and/or the target cell 701-2, the simultaneous service connection failure, a reason of the failure, location information of the terminal 702, information on a time elapsed until the connection re-establishment, connection configuration information (e.g., AS or RRC context information) with the serving cell 701-1, and the like. Therefore, the terminal 702 should continuously perform a monitoring procedure on the radio link with the serving cell 701-1 until the radio access procedure with the target cell 701-2 is completed.

In addition, if the terminal is not able to be connected to the serving cell 701-1 due to a radio link failure (RLF) or a beam recovery failure before the terminal 702 and the serving cell 701-1 before completion of the radio access procedure with the target cell 701-2, the terminal 702 may stop data transmission and/or reception without changing a connection state, and may perform an operation procedure according to the above-described RLF or a beam recovery operation procedure.

Meanwhile, the terminal 702, which has been receiving services from both of the cells 701-1 and 701-2 in the simultaneous service interval (e.g., interval 902 of FIGS. 9 and 10), may terminate the simultaneous service, and receive a service from a single cell (e.g., interval 903 of FIG. 9 or interval 904 of FIG. 10).

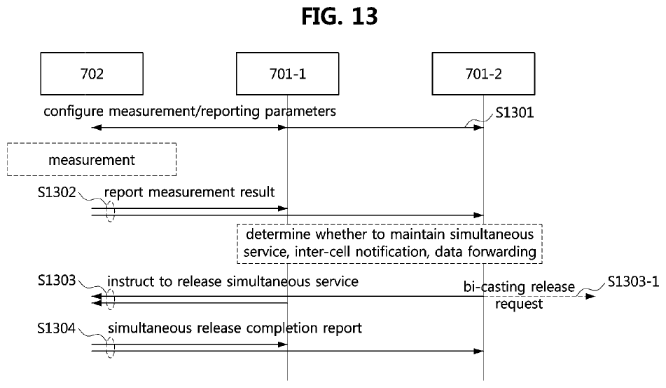

FIG. 13 is a sequence chart illustrating a mobility control method according to another exemplary embodiment of the present disclosure.

In FIG. 13, it is assumed that the terminal 702 is in a state of being provided with services simultaneously from the serving cell 701-1 and the target cell 701-2. That is, it is assumed that the terminal is operating in the interval 902 of FIGS. 9 and 10.

Referring to FIG. 13, the terminal 702 may receive services simultaneously from the serving cell 701-1 and the target cell 701-2, and may receive a control message including parameters for measurement and reporting required for mobility control from the serving cell 701-1 or the target cell 701-2 (S1301). Meanwhile, the step S1301 may be the step S1101 of FIG. 11 or the step S1201 of FIG. 12. That is, the step S1301 may be performed after the simultaneous service from the serving cell 701-1 and the target cell 701-2 is configured, or may be performed before the simultaneous service from the serving cell 701-1 and the target cell 701-2 is configured.

The terminal 702 may perform a measurement operation based on the configured parameters for measurement (or reporting), and report a measurement result to the serving cell 701-1 or the target cell 701-2 (S1302).

When one or more of the following conditions are satisfied, the terminal 702 may report the measurement result or transmit a related control message to the serving cell 701-1 and/or the target cell 701-2 (S1302). Which of the following conditions is to be used may be configured using a control message (e.g., the control message of the step S1301) or may be predefined by the technical specification.
A case when the radio channel quality for the serving cell or the target cell is worse than a reference value 3
A case when the radio channel quality for the serving cell or the target cell is better than the reference value 1
A case when the radio channel quality for the serving cell (or target cell) is worse than the reference value 3, and the radio channel quality for the target cell (or serving cell) is better than the reference value 1.

When the radio channel quality for the target cell 701-2 or the serving cell 701-1 satisfies the above-described condition or satisfies a separately configured simultaneous service release condition, the terminal 702 may transmit, to the serving cell 701-1 or the target cell 701-2, a control message requesting termination (or release) of the simultaneous service or informing that the condition for the termination (or release) of the simultaneous service is satisfied, by using the step S1302.

In the step S1302, when both of the radio channel qualities for the serving cell 701-1 and the target cell 701-2 are lower than the reference value 3, or both of the radio channel qualities for the serving cell 701-1 and the target cell 701-2 satisfy the separately configured simultaneous service release condition, the terminal 702 may determine whether to terminate (or release) the service from the serving cell 701-1 or the service from the target cell 701-2. The terminal 702, which has determined to release the simultaneous service, may transmit, to the cell determined to maintain the connection for the service even after the simultaneous service is released, a control message requesting the termination (or release) of the simultaneous service or informing that the simultaneous service release (or termination) condition is satisfied.

In this case, the condition (or reference parameter) for the terminal 702 to select (or determine) the target cell for the simultaneous service release (or termination) may be previously transmitted to the terminal 702 using a separate control message.

In the step S1302, the terminal 702 may transmit only information on an identifier of the target cell for the simultaneous service termination (or release) without the measurement result. However, when the measurement result is transmitted, the terminal 702 may transmit only the measurement result without the cell identifier, or may transmit the cell identifier and the measurement result together according to the parameters for measurement or reporting. When only the measurement result is transmitted, the order of inclusion of the measurement results in the report message may be preconfigured, and the cell may be identified only by the order of the measurement results in the report message.

The serving cell 701-1 and/or the target cell 701-2, which has received the control message requesting the simultaneous service termination (or, release) or informing that the condition for the simultaneous service termination, may determine whether to maintain the simultaneous service for the corresponding terminal 702.

The target cell 701-2 and/or the serving cell 701-1 having determined to release the simultaneous service may transmit a control message instructing the terminal 702 to release the simultaneous service (S1303). Alternatively, if the target cell 701-2 and the serving cell 701-1 having determined to release the simultaneous service share the determined information using inter-cell signaling, the cell maintaining the connection even after releasing the simultaneous service may transmit the control message of the step S1303 to the terminal 702.

Meanwhile, the target cell 701-2 and/or the serving cell 701-1 having determined to release the simultaneous service may transmit a control message requesting the release of the simultaneous service (i.e., bi-casting) to a related node (e.g., AMF or UPF) of the mobile network (S1303-1). If necessary, the cell which has released the simultaneous service may transmit the control message informing the simultaneous service release to the cell which has provided the simultaneous service together. In addition, if necessary, the cell that has released the simultaneous service may transmit data for the corresponding terminal 702 stored in a buffer to the cell which has provided the simultaneous service together.

The terminal 702 receiving the control message of the step S1303 may transmit a simultaneous service termination (or release) completion report message to the cell that transmitted the corresponding message (the target cell 701-2 or the serving cell 701-1) (S1304). In this case, the terminal 702 may transmit the control message informing the completion of the simultaneous service release to the cell which released the connection for the service.

In addition to the operation conditions based on the reference values for the radio channel quality described above, when one or more of the following conditions between the terminal and the serving cell or the target cell are satisfied, the terminal 702 may be controlled or configured to select (or, determine) the target cell for the simultaneous service release (or, termination).
A case when the radio link or radio bearer that requires the simultaneous service is released or a service related thereto is terminated
A case when a data rate is below a reference value until a preset timer expires
A case when retransmission according to an HARQ function fails (e.g., when the retransmission fails after the retransmissions are performed up to the maximum numbers)
A case when the maximum number of retransmissions fail at the RLC layer
A case when a SN successfully transmitted among SNs managed by an RLC or PDCP layer satisfies a simultaneous service release condition, or a case when a difference between SNs of both links is greater than a reference value (here, both links are a logical connection between the serving cell and the terminal and a logical connection between the target cell and the terminal)
A case when a packet transmission delay measured between both links is greater than a reference
A case when a beam failure or a radio link failure (RLF) occurs.

In addition, the terminal, the serving cell, or the target cell may be controlled or configured to select (or determine) the target cell for the simultaneous service release (or, termination) based on a timer (e.g., SimultaneousCell HOTimer). The SimultaneousCell HOTimer may be transferred to the terminal 702 using system information, an RRC layer control message, or the control message of the step S1105 or S1205 which the serving cell 710-1 uses to instruct the execution of the simultaneous service. The SimultaneousCell HOTimer may be configured to start at one of the following time points.
A time point at which the serving cell transmits the control message instructing to execute the simultaneous service to the terminal in the step S1105 of FIG. 11 or the step S1205 of FIG. 12, or a time point at which the terminal receives the corresponding control message
A time point at which the terminal transmits the radio access request message in the step S1106 of FIG. 11, or a time point at which the target cell receives the corresponding control message
A time point at which the target cell transmits the radio access response message in the step S1107 of FIG. 11, or a time point at which the terminal receives the corresponding control message
A time point at which the terminal transmits the simultaneous service configuration completion report message in the step S1108 of FIG. 11, or a time point at which the target cell receives the corresponding control message

When the terminal 702 is receiving the simultaneous service from the serving cell 701-1 and the target cell 701-2, if the SimultaneousCell HOTimer started according to the above condition expires, the terminal 702, the serving cell 701-1, or the target cell 701-2 may be controlled or configured to select (or determine) a target cell for the simultaneous service release (or termination). When the release (or termination) of the simultaneous service is determined, the terminal 702 may transmit a control message requesting the release (or, termination) of the simultaneous service. The terminal 702, and the serving cell 701-1 or the target cell 701-2 may perform the procedure of releasing (or terminating) the simultaneous service through the steps S1303 and S1304 of FIG. 13.

In the above procedures, packet data (or control messages) that the terminal 702 transmits to or receives from both of the cells 701-1 and 701-2 providing the simultaneous service may be transmitted using radio resources separated in the time or frequency domain. In a special case, packet data (or control messages) transmitted to or received from both of the cells 701-1 and 701-2 providing the simultaneous service may be transmitted or received through the same radio resource. In this case, the same radio resource may be a radio resource scheduled using a common scheduling identifier or a preconfigured common radio resource.

The reference values (e.g., reference value 1, reference value 2, or reference value 3) and the threshold values of the operation procedure for provision of the simultaneous service may be values to be compared with or applied to results measured and monitored during a preconfigured time (or, a time based on a timer). Also, in the above operation procedures, when a control message is transmitted by satisfying the reference values or the condition, a timer may be configured for each control message to control timing between a time point at which the reference value or condition is satisfied and a time point at which the control message is transmitted. Configuration values (or parameters) for such the timers may be delivered to the terminal through a separate control message.

In case that the simultaneous service-based handover procedure, in which the control message of S1108 in FIG. 11 or S1208 in FIG. 12 is successfully received at the target cell 701-2 after the connection establishment with the target cell 701-2 is completed, and the connection with the serving cell 701-1 is released, is applied, the procedure of FIG. 13 may be omitted.

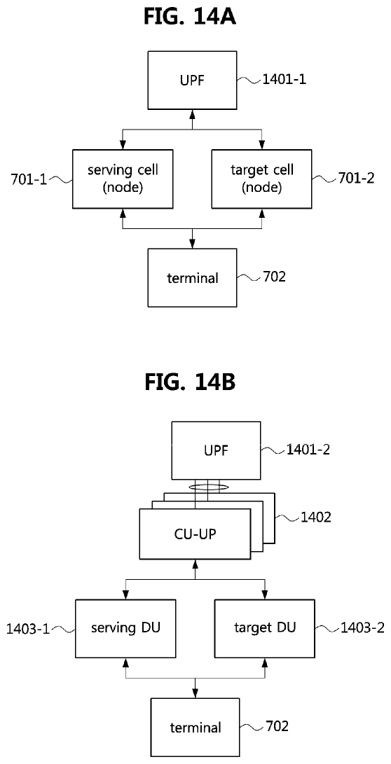

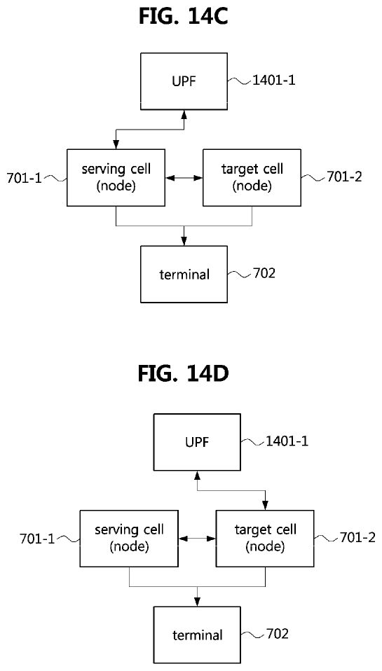

FIGS. 14A to 14D are conceptual diagrams illustrating examples of a data transmission path between a mobile network and a terminal in a mobility control method according to exemplary embodiments of the present disclosure.

Referring to FIG. 14A, when the simultaneous service is provided, a UPF 1201-1 responsible for a user data transfer function in a mobile network may exchange user data with both of two cells (e.g., the serving cell 701-1 and the target cell 701-2). In addition, the serving cell 701-1 and the target cell 701-2 may simultaneously perform user data transmission and reception with the terminal 702 using radio channels.

Referring to FIG. 14B, it is assumed that a cell (or base station) is configured as being split into a central unit (CU) and a distributed unit (DU). In case of providing the simultaneous service using the structure of FIG. 14B, a UPF 1401-2 responsible for a user data transfer function in a mobile network may exchange user data with one or more central unit-user planes (CU-UPs) 1402. In addition, the CU-UP 1402 may exchange user data with both DUs (e.g., serving DU 1403-1 and target DU 1403-2). In addition, the serving DU 1403-1 and the target DU 1403-2 may simultaneously perform user data transmission and reception with the terminal 702 using radio channels. In FIG. 14B, RRC functions are not shown, but they are performed in the CU-CP. If necessary, some functions of the RRC (e.g., physical layer radio resource configuration for the terminal, etc.) may be performed in the DU function, but they may be responsible for a partial role under control of the RRC function of the CU-CP.

The structures of FIGS. 14C and 14D show examples of providing the simultaneous service using a function of data transfer between the serving cell and the target cell. In the structure of FIG. 14C, the UPF 1401-1 responsible for the user data transfer function in the mobile network may exchange user data with the serving cell 701-1. Also, when the simultaneous service is determined to be provided, the serving cell 701-1 may transfer downlink user data to the target cell 701-2, and receive uplink user data from the target cell 701-2. In addition, the serving cell 701-1 and the target cell 701-2 may simultaneously perform user data transmission and reception with the terminal 702 using radio channels.

In the structure of FIG. 14C, the UPF 1201-1 responsible for the user data transfer function in the mobile network may exchange user data with the target cell 701-2. Also, when the simultaneous service is determined to be provided, the target cell 701-2 may transfer downlink user data to the serving cell 701-1, and receive uplink user data from the serving cell 701-1. Also, the serving cell 701-1 and the target cell 701-2 may simultaneously perform user data transmission and reception with the terminal 702.

In addition, when the CU and DU functions of the base station are split as shown in FIG. 14B and the simultaneous service is provided using the structures of FIGS. 14C and 14D, the user data transfer operation may be performed between serving DUs.

In case of user data transfer between cells (or DUs) for the simultaneous service, in the structure of FIG. 14A, packet data may be transmitted by the UPF as being copied (or duplicated) or split at the UPF. Alternatively, in the structure of FIG. 14B, packet data may be transmitted by the UPF or CU-UP as being copied (or duplicated) or split at the UPF or CU-UP. In addition, in the structure of FIG. 14C or 14D, packet data may be transmitted by a PDCP layer, an RLC layer, or a MAC layer of the serving cell or the target cell as being copied (or duplicated) or split at the corresponding layer.

In particular, in the structure of FIG. 14B, when the CU-UP comprises a PDCP layer, an RLC layer, or a MAC layer, the PDCP layer, RLC layer, or MAC layer of the CU-UP may perform the function of transmitting the packet data by copying (or duplicating) or splitting the packet data. When the CU-UP comprises the PDCP layer, the RLC layer, and a part of the MAC layer, the RLC layer or the MAC layer may perform the function of transmitting the packet data by copying (or duplicating) or splitting the packet data. When the CU-UP comprises all of the PDCP layer, the RLC layer, and the MAC layer, the RRH may perform the functions of 1403-1 and 1403-2. When the radio protocol functions constituting the cell (or base station) are configured as split, each of the entities 1403-1 and 1403-2 may be referred to as a transmission & reception point (TRP), a transmission point (TP), or a reception point (RP).

In case of providing the simultaneous service for supporting the handover or mobility function described above, the functions of the respective layers (e.g., RRC, SDAP, PDCP, RLC, MAC, physical layer, etc.) of the radio protocol of the serving cell and the target cell may exist independently, and may independently perform related functions for the terminal. However, in order to prepare or start the simultaneous service, configuration information or capability information necessary for efficient parameter configuration of each layer of the radio protocol between the serving cell and the target cell or between them and the terminal may be exchanged as a separate control message.

Accordingly, the terminal may independently configure and maintain a signaling radio bearer (SRB) for transmission of an RRC control message with both the serving cell and the target cell. In addition, radio resource allocation and the function of the MAC layer may also be independently performed for each cell. That is, in order to support the above-described simultaneous service, the terminal may independently configure the function of each layer (e.g., RRC, SDAP, PDCP, RLC, MAC, physical layer, etc.) of the radio protocol simultaneously with respect to the serving cell and the target cell. According to the procedure of FIG. 11 or FIG. 12, each layer of the radio protocol for the serving cell and the target cell may be selectively activated to operate simultaneously. For example, when the terminal receives the control message (or RRC reconfiguration control message) instructing to execute the simultaneous service in the step S1105 of FIG. 11, the terminal may generate the functions of the radio protocol layers (e.g., RRC, SDAP, PDCP, RLC, MAC, physical layer, etc.) for the target cell, and configure related parameters. In addition, when receiving the response message for the simultaneous service configuration completion notification of the step S1109 or S1209 from the target cell, the terminal may deactivate (or, stop) or delete (or, release) the functions for the radio protocol layers (e.g., RRC, SDAP, PDCP, RLC, MAC, physical layer, etc.) for the serving cell, and delete the relevant configuration parameters. In addition, when receiving the control message instructing to release the simultaneous service in the step S1303 of FIG. 13, the terminal may deactivate (or, stop) or delete (or, release) the functions for the radio protocol layers (e.g., RRC, SDAP, PDCP, RLC, MAC, physical layer, etc.) for the corresponding cell (serving cell or target cell), and delete the relevant configuration parameters.

As such, each layer function of the radio protocol for the serving cell and the target cell may be simultaneously configured or activated in the terminal. Packet information for a data radio bearer (DRB) or a signaling radio bearer may be transmitted or received simultaneously with the serving cell and the target cell, the packet information may be transmitted or received with the serving cell, or the packet information may be transmitted or received with the target cell. Therefore, the simultaneous service-based connection control or handover configuration described above may be configured based on a radio bearer (e.g., DRB or SRB) or a logical channel, and the corresponding configuration information may include a radio bearer identifier or a logical channel identifier.

In addition, the same method and procedure of the control and data transmission functions of the radio protocol for providing the simultaneous cell service described above may be applied even when radio access technologies (RATs) of the serving cell and the target cell are different. In this case, the control message and procedure may be performed according to the type of message or the control signaling procedure defined in the corresponding RAT.

When a BFR or an RLF occurs while performing the mobility function (or handover) based on the above-described simultaneous service or performing the mobility function (or handover) without supporting the simultaneous service function, the base station and the terminal may be controlled to store (or maintain) RRC context (or AS context) until a preset timer (e.g., T_{RRC_CONT}) expires. Therefore, in the case that a BFR or an RLF occurs while performing the mobility function (or handover) and the RRC connection is re-established, if the RRC connection re-establishment is successfully completed before the preset timer T_{RRC_CONT} expires, the base station and the terminal may reuse the stored RRC context (or AS context) information. In this case, some parameters may be reconfigured based on the above-described measurement result transmitted by the terminal in a contention-based or non-contention-based RA procedure (or after the RA procedure) performed in the RRC connection re-establishment procedure. In this case, through the RRC connection re-establishment procedure, only partial configuration parameters of the RRC context (or AS context) configuration information between the base station and the terminal may be updated (or changed), and the stored RRC context (or AS context) information may be reused. For example, the beam configuration or BWP configuration parameters may be newly configured and the existing configuration information may be maintained. To this end, the base station may configure T_{RRC_CONT} and transmit configuration information of T_{RRC_CONT} to the terminal using system information or a dedicated control message.

All the steps of the above-described procedures may not be necessarily performed to support the mobility function, and may be selectively performed when a preconfigured condition is satisfied. That is, some steps of the above procedures may be omitted or two or more steps may be performed as combined. In addition, the control message for each procedure may be configured and transmitted in form of a field parameter of a physical control channel, a MAC control element (CE), or an RRC control message for a radio section between the base station and the terminal.

With respect to the operation of the timer defined or described in the present disclosure, although operations such as start, stop, reset, restart, or expire of the defined timer are not separately described, they mean or include the operations of the corresponding timer or a counter for the corresponding timer.

The cell (or base station) of the present disclosure may refer to a road side unit (RSU), a radio remote head (RRH), a transmission point (TP), a transmission and reception point (TRP), or a gNB, in addition to the NodeB, the evolved NodeB, the base transceiver station (BTS), the radio base station, the radio transceiver, the access point, or the access node as the base station described in FIG. 1. It may also be referred to as a CU node or a DU node according to application of the functional split described in FIG. 4.

Also, the terminal of the present disclosure may refer to an Internet of Thing (IoT) device, a mounted module/device/terminal, or an on board device/terminal, in addition to the terminal, the access terminal, the mobile terminal, the station, the subscriber station, the mobile station, the mobile subscriber station, the node, or the device as the UE described in FIG. 1.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. An operation method for a handover, performed by a terminal, the operation method comprising:
receiving, from a base station of a serving cell, a first message including parameters for measurement and reporting;
transmitting a second message to the base station of the serving cell, the second message including a measurement result based on the parameters for measurement and reporting;
receiving a third message from the base station of the serving cell, the third message instructing to receive services simultaneously from the serving cell and a target cell;
performing a radio access request procedure with the target cell; and
transmitting a fourth message to the base station of the serving cell, the fourth message reporting completion of configuration for receiving the services simultaneously from the serving cell and the target cell.

2. The operation method according to claim 1, wherein the second message includes information indicating that the terminal requests to receive the services simultaneously from the serving cell and the target cell or information reporting satisfaction of a first condition for the terminal to receive the services simultaneously from the serving cell and the target cell.

3. The operation method according to claim 2, wherein the first condition is a condition of satisfying at least one of:
a case when a radio channel quality for the serving cell is worse than a first reference value;
a case when a radio channel quality for the target cell is better than a second reference value;
a case when the radio channel quality for the serving cell is worse than the first reference value and the radio channel quality for the target cell is better than the second reference value; and
a case when a difference between the radio channel quality for the serving cell and the radio channel quality for the target cell satisfies a preconfigured reference value.

4. The operation method according to claim 3, further comprising in response to satisfaction of a second condition for determining that the terminal is not able to receive the services simultaneously from the serving cell and the target cell, transmitting a fifth message to the serving cell and/or the target cell.

5. The operation method according to claim 4, wherein the second condition is a condition of satisfying at least one of:
a case when the radio channel quality for the serving cell or the target cell is worse than a third reference value;
a case when the radio channel quality for the serving cell or the target cell is better than the first reference value; and
a case when the radio channel quality for the serving cell (or the target cell) is worse than the third reference value and the radio channel quality for the target cell (or the serving cell) is better than the first reference value.

6. The operation method according to claim 1, further comprising transmitting, to the base station of the serving cell, capability information indicating that the terminal is capable of receiving the services simultaneously from the serving cell and the target cell.

7. The operation method according to claim 1, wherein the third message includes at least one of a reference condition or threshold value of a radio channel for receiving a simultaneous service, a parameter for performing an operation, a triggering condition, a measurement or reporting reference value or threshold value, or a related timer configuration parameter.

8. The operation method according to claim 1, wherein the base station of the serving cell determines that the serving cell and the target cell are to simultaneously provide the services to the terminal, a base station of the target cell accepts the determination, and then the base station of the serving cell transmits the third message.

9. The operation method according to claim 1, wherein the base station of the serving cell requests a handover of the terminal to a base station of the target cell, the base station of the target cell determines that the serving cell and the target cell are to simultaneously provide the services to the terminal, the base station of the serving cell accepts the determination, and then the base station of the serving cell transmits the third message.

10. The operation method according to claim 9, wherein when the base station of the serving cell requests the handover of the terminal to the base station of the target cell, information informing that a simultaneous service triggered by the base station of the target cell can be provided, information on the target cell, that allows the base station of the target cell to trigger the simultaneous service, or capability information of the terminal informing whether the terminal is capable of supporting the simultaneous service is transferred to the base station of the target cell.

11. An operation method for a handover of a terminal, performed by a base station of a serving cell, the operation method comprising:
transmitting, to the terminal, a first message including parameters for measurement and reporting;
receiving, from the terminal, a second message including a measurement result based on the parameters for measurement and reporting;
determining whether the serving cell and a target cell simultaneously provide services to the terminal based on the measurement result, or requesting a handover of the terminal to a base station of the target ell and receiving, from the base station of target cell, a result of determination on whether the serving cell and the target cell simultaneously provide the services to the terminal;
in response to determination that the serving cell and the target cell simultaneously provide the services to the terminal, transmitting, to the terminal, a third message instructing the terminal to receive the services simultaneously from the serving cell and the target cell; and
receiving, from the terminal, a fourth message reporting completion of configuration for receiving the services simultaneously from the serving cell and the target cell.

12. The operation method according to claim 11, wherein the second message includes information that the terminal requests to receive the services simultaneously from the serving cell and the target cell or information reporting satisfaction of a first condition for the terminal to receive the services simultaneously from the serving cell and the target cell.

13. The operation method according to claim 12, wherein the first condition is a condition of satisfying at least one of:
a case when a radio channel quality for the serving cell is worse than a first reference value;
a case when a radio channel quality for the target cell is better than a second reference value;
a case when the radio channel quality for the serving cell is worse than the first reference value and the radio channel quality for the target cell is better than the second reference value; and
a case when a difference between the radio channel quality for the serving cell and the radio channel quality for the target cell satisfies a preconfigured reference value.

14. The operation method according to claim 13, further comprising in response to satisfaction of a second condition for determining that the terminal is not able to receive the services simultaneously from the serving cell and the target cell, receiving a fifth message from the terminal.

15. The operation method according to claim 14, wherein the second condition is a condition of satisfying at least one of:
a case when the radio channel quality for the serving cell or the target cell is worse than a third reference value;
a case when the radio channel quality for the serving cell or the target cell is better than the first reference value; and
a case when the radio channel quality for the serving cell (or the target cell) is worse than the third reference value and the radio channel quality for the target cell (or the serving cell) is better than the first reference value.

16. The operation method according to claim 11, wherein the third message includes at least one of a reference condition or threshold value of a radio channel for receiving a simultaneous service, a parameter for performing an operation, a triggering condition, a measurement or reporting reference value or threshold value, or a related timer configuration parameter.

17. An operation method for a handover of a terminal, performed by a base station of a target cell, the operation method comprising:
receiving, from a base station of a serving cell, a first message requesting a handover of the terminal and determining whether the serving cell and the target cell simultaneously provide services to the terminal, or receiving, from the base station of the serving cell, information indicating that the serving cell and the target cell are to simultaneously provide the services to the terminal;
transmitting, to the base station of the serving cell, a second message including a result of the determination;
performing a radio access request procedure with the terminal; and
receiving, from the terminal, a third message reporting completion of configuration for receiving the services simultaneously from the serving cell and the target cell.

18. The operation method according to claim 17, wherein the first message includes information indicating that the terminal requests to receive the services simultaneously from the serving cell and the target cell, or information reporting satisfaction of a first condition for the terminal to receive the services simultaneously from the serving cell and the target cell.

19. The operation method according to claim 18, wherein the first condition is a condition of satisfying at least one of:
a case when a radio channel quality for the serving cell is worse than a first reference value;
a case when a radio channel quality for the target cell is better than a second reference value;
a case when the radio channel quality for the serving cell is worse than the first reference value and the radio channel quality for the target cell is better than the second reference value; and
a case when a difference between the radio channel quality for the serving cell and the radio channel quality for the target cell satisfies a preconfigured reference value.

20. The operation method according to claim 17, further comprising in response to satisfaction of a second condition for determining that the terminal is not able to receive the services simultaneously from the serving cell and the target cell, receiving a fifth message from the terminal.
